(19) United States
(12) Patent Application Publication
(10) Pub. No.: US 2025/0220528 A1
(43) Pub. Date: Jul. 3, 2025

(54) COMMUNICATION USING A CROSS-CARRIER CONFIGURATION FOLLOWING A SERVING CELL CHANGE

(71) Applicant: QUALCOMM Incorporated, San Diego, CA (US)

(72) Inventors: Fang YUAN, Beijing (CN); Yan ZHOU, San Diego, CA (US); Jelena DAMNJANOVIC, Del Mar, CA (US); Tao LUO, San Diego, CA (US)

(21) Appl. No.: 18/867,200

(22) PCT Filed: Jul. 19, 2022
(86) PCT No.: PCT/CN2022/106419

§ 371 Date: Nov. 19, 2024

(51) Int. Cl. H04W 36/08; H04W 36/00

(52) U.S. Cl. CPC H04W 36/08; H04W 36/0061; H04W 36/0064

(57) ABSTRACT

Various aspects of the present disclosure generally relate to wireless communication. In some aspects, a user equipment (UE) may receive information that indicates a configuration for a first cell associated with a first cell identifier, the configuration referencing a second cell identifier associated with a second cell that is a serving cell. The UE may receive an indication that the serving cell is to change from the second cell to a third cell associated with a third cell identifier. The UE may communicate according to the configuration by using the second cell identifier for the third cell and the third cell identifier for the second cell. Numerous other aspects are described.

### INTRODUCTION

Aspects of the present disclosure generally relate to wireless communication and to techniques and apparatuses for communication using a cross-carrier configuration.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed at a user equipment (UE). The method may include receiving information that indicates a configuration for a first cell associated with a first cell identifier, the configuration referencing a second cell identifier associated with a second cell that is a serving cell. The method may include receiving an indication that the serving cell is to change from the second cell to a third cell associated with a third cell identifier. The method may include communicating according to the configuration by using the second cell identifier for the third cell and the third cell identifier for the second cell.

Some aspects described herein relate to a method of wireless communication performed at a UE. The method may include receiving information that indicates a configuration for a first cell associated with a first cell identifier, the configuration referencing a second cell identifier associated with a second cell that is a serving cell. The method may include receiving an indication that the serving cell is to change from the second cell to a third cell associated with a third cell identifier. The method may include communicating according to the configuration by replacing the second cell identifier in the configuration with the third cell identifier.

Some aspects described herein relate to a method of wireless communication performed at a UE. The method may include receiving information that indicates a configuration for a first cell associated with a first cell identifier, the configuration referencing a second cell identifier associated with a second cell that is a serving cell.

The method may include receiving an indication that the serving cell is to change from the second cell to a third cell associated with a third cell identifier. The method may include communicating, responsive to the indication, independently of the configuration.

Some aspects described herein relate to a method of wireless communication performed at a network node. The method may include transmitting information that indicates a configuration for a first cell associated with a first cell identifier, the configuration referencing a second cell identifier associated with a second cell that is a serving cell. The method may include transmitting an indication that the serving cell is to change from the second cell to a third cell associated with a third cell identifier. The method may include communicating according to the configuration by using the second cell identifier for the third cell and the third cell identifier for the second cell.

Some aspects described herein relate to a method of wireless communication performed at a network node. The method may include transmitting information that indicates a configuration for a first cell associated with a first cell identifier, the configuration referencing a second cell identifier associated with a second cell that is a serving cell. The method may include transmitting an indication that the serving cell is to change from the second cell to a third cell associated with a third cell identifier. The method may include communicating according to the configuration by replacing the second cell identifier in the configuration with the third cell identifier.

Some aspects described herein relate to a method of wireless communication performed at a network node. The method may include transmitting information that indicates a configuration for a first cell associated with a first cell identifier, the configuration referencing a second cell identifier associated with a second cell that is a serving cell. The method may include transmitting an indication that the serving cell is to change from the second cell to a third cell associated with a third cell identifier. The method may include communicating, responsive to the indication, independently of the configuration.

Some aspects described herein relate to an apparatus for wireless communication at a UE. The apparatus may include a memory and one or more processors coupled to the memory. The one or more processors may be configured to obtain information that indicates a configuration for a first cell associated with a first cell identifier, the configuration referencing a second cell identifier associated with a second cell that is a serving cell. The one or more processors may be configured to obtain an indication that the serving cell is to change from the second cell to a third cell associated with a third cell identifier. The one or more processors may be configured to communicate according to the configuration by using the second cell identifier for the third cell and the third cell identifier for the second cell.

Some aspects described herein relate to an apparatus for wireless communication at a UE. The apparatus may include a memory and one or more processors coupled to the memory. The one or more processors may be configured to obtain information that indicates a configuration for a first cell associated with a first cell identifier, the configuration referencing a second cell identifier associated with a second cell that is a serving cell. The one or more processors may be configured to obtain an indication that the serving cell is to change from the second cell to a third cell associated with a third cell identifier. The one or more processors may be configured to communicate according to the configuration by replacing the second cell identifier in the configuration with the third cell identifier.

Some aspects described herein relate to an apparatus for wireless communication at a UE. The apparatus may include a memory and one or more processors coupled to the memory. The one or more processors may be configured to obtain information that indicates a configuration for a first cell associated with a first cell identifier, the configuration referencing a second cell identifier associated with a second cell that is a serving cell. The one or more processors may be configured to obtain an indication that the serving cell is to change from the second cell to a third cell associated with a third cell identifier. The one or more processors may be configured to communicate, responsive to the indication, independently of the configuration.

Some aspects described herein relate to an apparatus for wireless communication at a network node. The apparatus may include a memory and one or more processors coupled to the memory. The one or more processors may be configured to provide information that indicates a configuration for a first cell associated with a first cell identifier, the configuration referencing a second cell identifier associated with a second cell that is a serving cell. The one or more processors may be configured to provide an indication that the serving cell is to change from the second cell to a third cell associated with a third cell identifier. The one or more processors may be configured to communicate according to the configuration by using the second cell identifier for the third cell and the third cell identifier for the second cell.

Some aspects described herein relate to an apparatus for wireless communication at a network node. The apparatus may include a memory and one or more processors coupled to the memory. The one or more processors may be configured to provide information that indicates a configuration for a first cell associated with a first cell identifier, the configuration referencing a second cell identifier associated with a second cell that is a serving cell. The one or more processors may be configured to provide an indication that the serving cell is to change from the second cell to a third cell associated with a third cell identifier. The one or more processors may be configured to communicate according to the configuration by replacing the second cell identifier in the configuration with the third cell identifier.

Some aspects described herein relate to an apparatus for wireless communication at a network node. The apparatus may include a memory and one or more processors coupled to the memory. The one or more processors may be configured to provide information that indicates a configuration for a first cell associated with a first cell identifier, the configuration referencing a second cell identifier associated with a second cell that is a serving cell. The one or more processors may be configured to provide an indication that the serving cell is to change from the second cell to a third cell associated with a third cell identifier. The one or more processors may be configured to communicate, responsive to the indication, independently of the configuration.

Some aspects described herein relate to a non-transitory computer-readable medium that stores a set of instructions for wireless communication by a UE. The set of instructions, when executed by one or more processors of the UE, may cause the UE to receive information that indicates a configuration for a first cell associated with a first cell identifier, the configuration referencing a second cell identifier associated with a second cell that is a serving cell. The set of instructions, when executed by one or more processors of the UE, may cause the UE to receive an indication that the serving cell is to change from the second cell to a third cell associated with a third cell identifier. The set of instructions, when executed by one or more processors of the UE, may cause the UE to communicate according to the configuration by using the second cell identifier for the third cell and the third cell identifier for the second cell.

Some aspects described herein relate to a non-transitory computer-readable medium that stores a set of instructions for wireless communication by a UE. The set of instructions, when executed by one or more processors of the UE, may cause the UE to receive information that indicates a configuration for a first cell associated with a first cell identifier, the configuration referencing a second cell identifier associated with a second cell that is a serving cell. The set of instructions, when executed by one or more processors of the UE, may cause the UE to receive an indication that the serving cell is to change from the second cell to a third cell associated with a third cell identifier. The set of instructions, when executed by one or more processors of the UE, may cause the UE to communicate according to the configuration by replacing the second cell identifier in the configuration with the third cell identifier.

Some aspects described herein relate to a non-transitory computer-readable medium that stores a set of instructions for wireless communication by a UE. The set of instructions, when executed by one or more processors of the UE, may cause the UE to receive information that indicates a configuration for a first cell associated with a first cell identifier, the configuration referencing a second cell identifier associated with a second cell that is a serving cell. The set of instructions, when executed by one or more processors of the UE, may cause the UE to receive an indication that the serving cell is to change from the second cell to a third cell associated with a third cell identifier. The set of instructions, when executed by one or more processors of the UE, may cause the UE to communicate, responsive to the indication, independently of the configuration.

Some aspects described herein relate to a non-transitory computer-readable medium that stores a set of instructions for wireless communication by a network node. The set of instructions, when executed by one or more processors of the network node, may cause the network node to transmit information that indicates a configuration for a first cell associated with a first cell identifier, the configuration referencing a second cell identifier associated with a second cell that is a serving cell. The set of instructions, when executed by one or more processors of the network node, may cause the network node to transmit an indication that the serving cell is to change from the second cell to a third cell associated with a third cell identifier. The set of instructions, when executed by one or more processors of the network node, may cause the network node to communicate according to the configuration by using the second cell identifier for the third cell and the third cell identifier for the second cell.

Some aspects described herein relate to a non-transitory computer-readable medium that stores a set of instructions for wireless communication by a network node. The set of instructions, when executed by one or more processors of the network node, may cause the network node to transmit information that indicates a configuration for a first cell associated with a first cell identifier, the configuration referencing a second cell identifier associated with a second cell that is a serving cell. The set of instructions, when executed by one or more processors of the network node, may cause the network node to transmit an indication that the serving cell is to change from the second cell to a third cell associated with a third cell identifier. The set of instructions, when executed by one or more processors of the network node, may cause the network node to communicate according to the configuration by replacing the second cell identifier in the configuration with the third cell identifier.

Some aspects described herein relate to a non-transitory computer-readable medium that stores a set of instructions for wireless communication by a network node. The set of instructions, when executed by one or more processors of the network node, may cause the network node to transmit information that indicates a configuration for a first cell associated with a first cell identifier, the configuration referencing a second cell identifier associated with a second cell that is a serving cell. The set of instructions, when executed by one or more processors of the network node, may cause the network node to transmit an indication that the serving cell is to change from the second cell to a third cell associated with a third cell identifier. The set of instructions, when executed by one or more processors of the network node, may cause the network node to communicate, responsive to the indication, independently of the configuration.

Some aspects described herein relate to an apparatus for wireless communication. The apparatus may include means for receiving information that indicates a configuration for a first cell associated with a first cell identifier, the configuration referencing a second cell identifier associated with a second cell that is a serving cell. The apparatus may include means for receiving an indication that the serving cell is to change from the second cell to a third cell associated with a third cell identifier. The apparatus may include means for communicating according to the configuration by using the second cell identifier for the third cell and the third cell identifier for the second cell.

Some aspects described herein relate to an apparatus for wireless communication. The apparatus may include means for receiving information that indicates a configuration for a first cell associated with a first cell identifier, the configuration referencing a second cell identifier associated with a second cell that is a serving cell. The apparatus may include means for receiving an indication that the serving cell is to change from the second cell to a third cell associated with a third cell identifier. The apparatus may include means for communicating according to the configuration by replacing the second cell identifier in the configuration with the third cell identifier.

Some aspects described herein relate to an apparatus for wireless communication. The apparatus may include means for receiving information that indicates a configuration for a first cell associated with a first cell identifier, the configuration referencing a second cell identifier associated with a second cell that is a serving cell. The apparatus may include means for receiving an indication that the serving cell is to change from the second cell to a third cell associated with a third cell identifier. The apparatus may include means for communicating, responsive to the indication, independently of the configuration.

Some aspects described herein relate to an apparatus for wireless communication. The apparatus may include means for transmitting information that indicates a configuration for a first cell associated with a first cell identifier, the configuration referencing a second cell identifier associated with a second cell that is a serving cell. The apparatus may include means for transmitting an indication that the serving cell is to change from the second cell to a third cell associated with a third cell identifier. The apparatus may include means for communicating according to the configuration by using the second cell identifier for the third cell and the third cell identifier for the second cell.

Some aspects described herein relate to an apparatus for wireless communication. The apparatus may include means for transmitting information that indicates a configuration for a first cell associated with a first cell identifier, the configuration referencing a second cell identifier associated with a second cell that is a serving cell. The apparatus may include means for transmitting an indication that the serving cell is to change from the second cell to a third cell associated with a third cell identifier. The apparatus may include means for communicating according to the configuration by replacing the second cell identifier in the configuration with the third cell identifier.

Some aspects described herein relate to an apparatus for wireless communication. The apparatus may include means for transmitting information that indicates a configuration for a first cell associated with a first cell identifier, the configuration referencing a second cell identifier associated with a second cell that is a serving cell. The apparatus may include means for transmitting an indication that the serving cell is to change from the second cell to a third cell associated with a third cell identifier. The apparatus may include means for communicating, responsive to the indication, independently of the configuration.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4A-4D are diagrams illustrating examples associated with communication using a cross-carrier configuration following a serving cell change, in accordance with the present disclosure.

FIG. 5 is a diagram of an example associated with communication using a cross-carrier configuration following a serving cell change, in accordance with the present disclosure.

FIGS. 6-11 are diagrams illustrating example processes associated with communication using a cross-carrier configuration following a serving cell change, in accordance with the present disclosure.

FIG. 12 is a diagram of an example apparatus for wireless communication, in accordance with the present disclosure.

FIG. 13 is a diagram illustrating an example of a hardware implementation for an apparatus employing a processing system, in accordance with the present disclosure.

FIG. 14 is a diagram illustrating an example of an implementation of code and circuitry for an apparatus, in accordance with the present disclosure.

FIG. 15 is a diagram of an example apparatus for wireless communication, in accordance with the present disclosure.

FIG. 16 is a diagram illustrating an example of a hardware implementation for an apparatus employing a processing system, in accordance with the present disclosure.

FIG. 17 is a diagram illustrating an example of an implementation of code and circuitry for an apparatus, in accordance with the present disclosure.

### DETAILED DESCRIPTION

“Carrier” may refer to a range of frequencies used for communication. In carrier aggregation, two or more carriers (which may be referred to as “component carriers” in the context of carrier aggregation) may be combined (e.g., into a single channel) for a user equipment (UE) to enhance data capacity. In carrier aggregation, the UE may be configured with a primary carrier or primary cell (PCell) and one or more secondary carriers or secondary cells (SCells). “Cell” may refer to a coverage area of a network node and/or a network node subsystem serving this coverage area. The PCell and SCell(s) may be serving cells for the UE. “Serving cell” may refer to a cell for which the UE has an active connection (e.g., an active radio resource control (RRC) connection). In some examples, the primary carrier may carry control information (e.g., downlink control information (DCI) and/or scheduling information) for scheduling data communications on one or more secondary carriers, which may be referred to as “cross-carrier scheduling.”

The UE may receive, from a network node, a configuration for a cell (e.g., an SCell), and the configuration may reference a serving cell (e.g., a PCell) using a cell identifier. Such a configuration for one cell that references another cell may be referred to as a “cross-carrier configuration.” After receiving the configuration, the UE may move to, or beyond, an edge of a coverage area of the serving cell. This may result in the UE receiving, from the network node, an indication (e.g., a dynamic indication) to change from the serving cell (i.e., the original serving cell) to a new serving cell (e.g., a new serving cell associated with a coverage area that is entered by the UE). However, the UE may not receive an update to the configuration that references the cell identifier of the original serving cell at the same time that the UE receives the indication to change the serving cell to the new serving cell. In other words, according to one or more examples, the reference to the cell identifier in the configuration becomes invalid when the UE receives the indication to change the serving cell to the new serving cell. Accordingly, if the UE continues to communicate in accordance with the configuration, which includes the invalid reference, then the performance of such communications may be affected.

Some techniques and apparatuses described herein improve communications of a UE when the UE receives, from a network node, a cross-carrier configuration that includes a reference to a cell identifier of a serving cell, and the reference to the cell identifier becomes invalid due to the UE subsequently receiving, from the network node, an indication to change from the serving cell (i.e., the original serving cell) to a new serving cell. For example, as described above, the UE may receive the indication responsive to the UE moving away from a coverage area of the original serving cell and to a coverage area of the new serving cell. In some aspects, based at least in part on the cross-carrier configuration having the invalid reference to the cell identifier of the original serving cell, the UE may communicate according to the cross-carrier configuration by using the cell identifier of the original serving cell for the new serving cell and a cell identifier of the new serving cell for the original serving cell (e.g., the cell identifiers of the original serving cell and the new serving cell are swapped). In other words, according to one or more examples, the UE may assume, in the absence of signaling from the network node to update the cross-carrier configuration, that a reference to the cell identifier of the original serving cell in the configuration is actually referencing the new serving cell. In this way, by assuming that the cross-carrier configuration is referencing a current serving cell of the UE (rather than a previous serving cell of the UE), the configuration remains valid, thereby improving the performance of communications of the UE following the change from the original serving cell to the new serving cell.

In some aspects, based at least in part on the cross-carrier configuration having the invalid reference to the cell identifier of the original serving cell, the UE may communicate according to the cross-carrier configuration by replacing the cell identifier of the original serving cell in the configuration with a cell identifier of the new serving cell. In other words, the UE may assume, in the absence of signaling from the network node to update the cross-carrier configuration, that a reference to the cell identifier of the original serving cell in the configuration is replaced with a reference to the cell identifier of the new serving cell. In this way, by assuming that the cross-carrier configuration is updated to reference a cell identifier of a current serving cell of the UE (rather than a previous serving cell of the UE), the configuration remains valid, thereby improving the performance of communications of the UE following the change from the original serving cell to the new serving cell.

In some aspects, based at least in part on the cross-carrier configuration having the invalid reference to the cell identifier of the original serving cell, the UE may communicate independently of the cross-carrier configuration (e.g., with the configuration suspended) until an update to the configuration is received by the UE. For example, the UE may use one or more default settings, instead of one or more settings indicated by the cross-carrier configuration, until an update to the configuration is received by the UE. In this way, the outdated reference in the cross-carrier configuration does not adversely affect the performance of communications of the UE following the change from the original serving cell to the new serving cell.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

In some aspects, the term “receive” and its conjugates (e.g., “receiving” and/or “received,” among other examples) may be alternatively referred to as “obtain” or its respective conjugates (e.g., “obtaining” and/or “obtained,” among other examples). Similarly, the term “transmit” and its conjugates (e.g., “transmitting” and/or “transmitted,” among other examples) may be alternatively referred to as “provide” or its respective conjugates (e.g., “providing” and/or “provided,” among other examples), “generate” or its respective conjugates (e.g., “generating” and/or “generated,” among other examples), and/or “output” or its respective conjugates (e.g., “outputting” and/or “outputted,” among other examples).

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

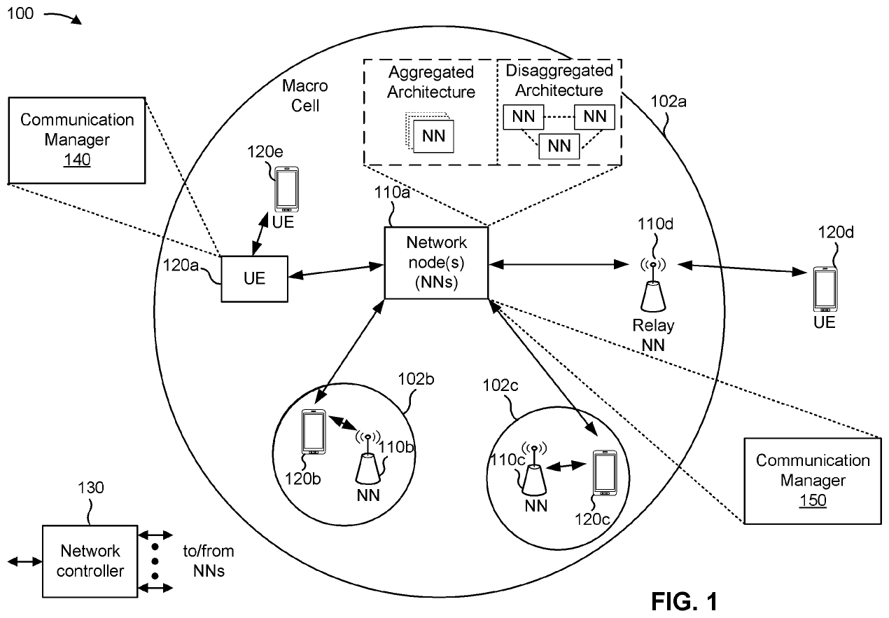

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. In some aspects, and as described in more detail elsewhere herein, the communication manager 140 may receive information that indicates a configuration for a first cell associated with a first cell identifier, the configuration referencing a second cell identifier associated with a second cell that is a serving cell; receive an indication that the serving cell is to change from the second cell to a third cell associated with a third cell identifier; and communicate according to the configuration by using the second cell identifier for the third cell and the third cell identifier for the second cell. In some aspects, and as described in more detail elsewhere herein, the communication manager 140 may receive information that indicates a configuration for a first cell associated with a first cell identifier, the configuration referencing a second cell identifier associated with a second cell that is a serving cell; receive an indication that the serving cell is to change from the second cell to a third cell associated with a third cell identifier; and communicate according to the configuration by replacing the second cell identifier in the configuration with the third cell identifier. In some aspects, and as described in more detail elsewhere herein, the communication manager 140 may receive information that indicates a configuration for a first cell associated with a first cell identifier, the configuration referencing a second cell identifier associated with a second cell that is a serving cell; receive an indication that the serving cell is to change from the second cell to a third cell associated with a third cell identifier; and communicate, responsive to the indication, independently of the configuration. Additionally, or alternatively, the communication manager 140 may perform one or more other operations described herein.

In some aspects, the network node 110 may include a communication manager 150. In some aspects, and as described in more detail elsewhere herein, the communication manager 150 may transmit information that indicates a configuration for a first cell associated with a first cell identifier, the configuration referencing a second cell identifier associated with a second cell that is a serving cell; transmit an indication that the serving cell is to change from the second cell to a third cell associated with a third cell identifier; and communicate according to the configuration by using the second cell identifier for the third cell and the third cell identifier for the second cell. In some aspects, and as described in more detail elsewhere herein, the communication manager 150 may transmit information that indicates a configuration for a first cell associated with a first cell identifier, the configuration referencing a second cell identifier associated with a second cell that is a serving cell; transmit an indication that the serving cell is to change from the second cell to a third cell associated with a third cell identifier; and communicate according to the configuration by replacing the second cell identifier in the configuration with the third cell identifier. In some aspects, and as described in more detail elsewhere herein, the communication manager 150 may transmit information that indicates a configuration for a first cell associated with a first cell identifier, the configuration referencing a second cell identifier associated with a second cell that is a serving cell; transmit an indication that the serving cell is to change from the second cell to a third cell associated with a third cell identifier; and communicate, responsive to the indication, independently of the configuration. Additionally, or alternatively, the communication manager 150 may perform one or more other operations described herein.

As indicated above, FIG. 1 is provided as an example. Other examples may differ from what is described with regard to FIG. 1.

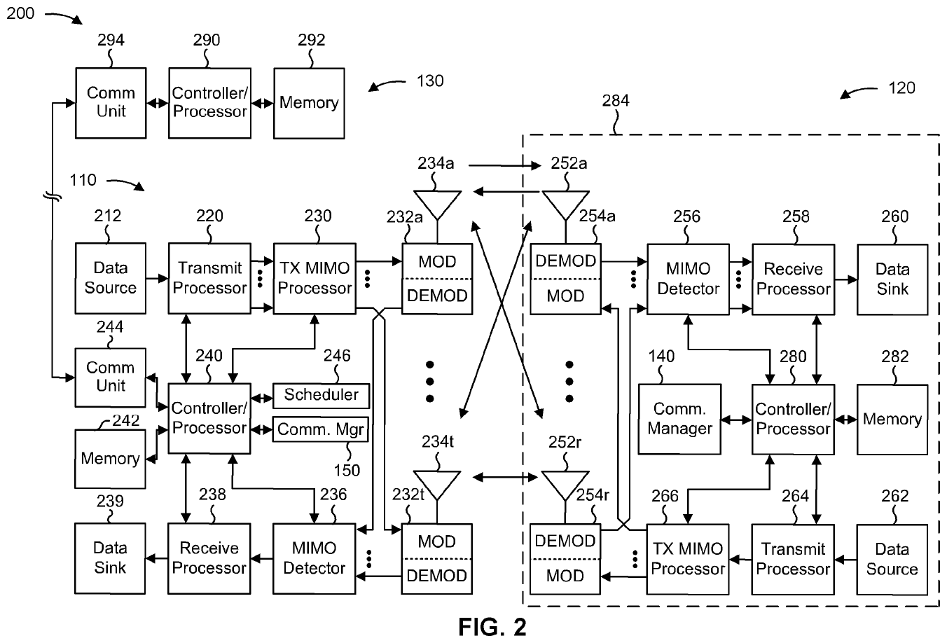

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

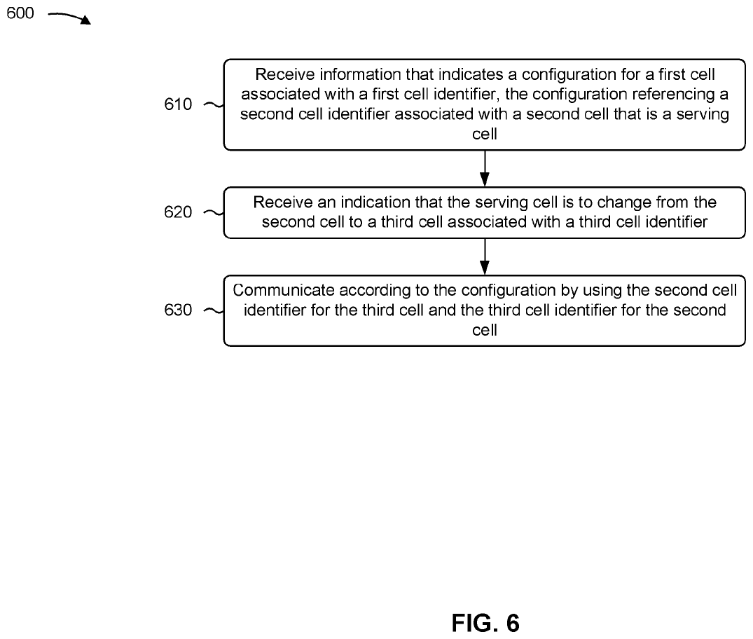

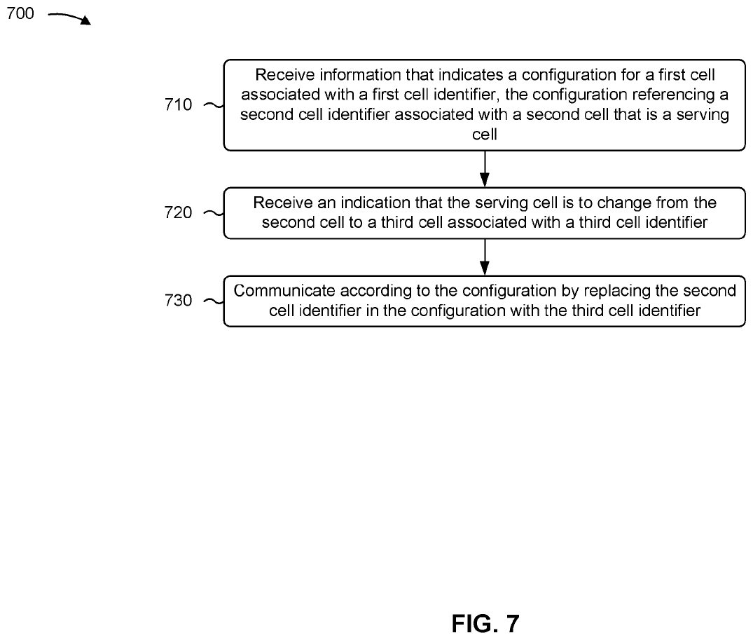

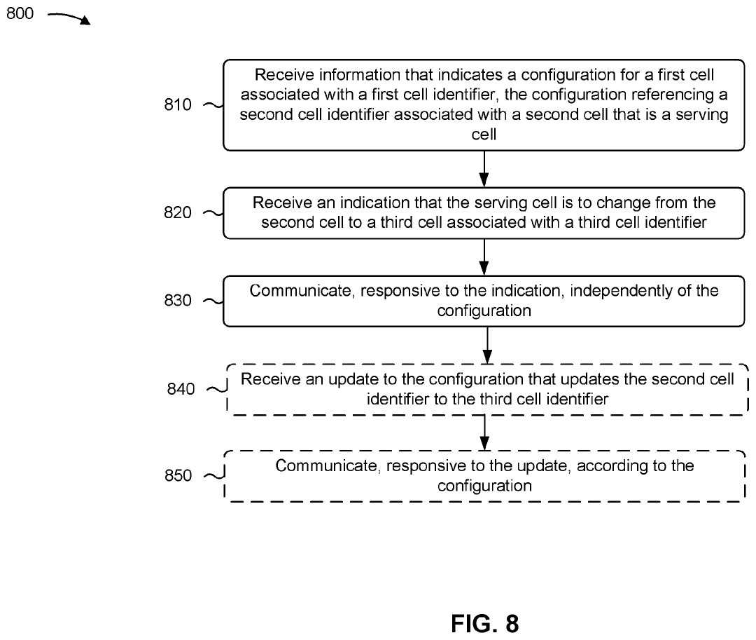

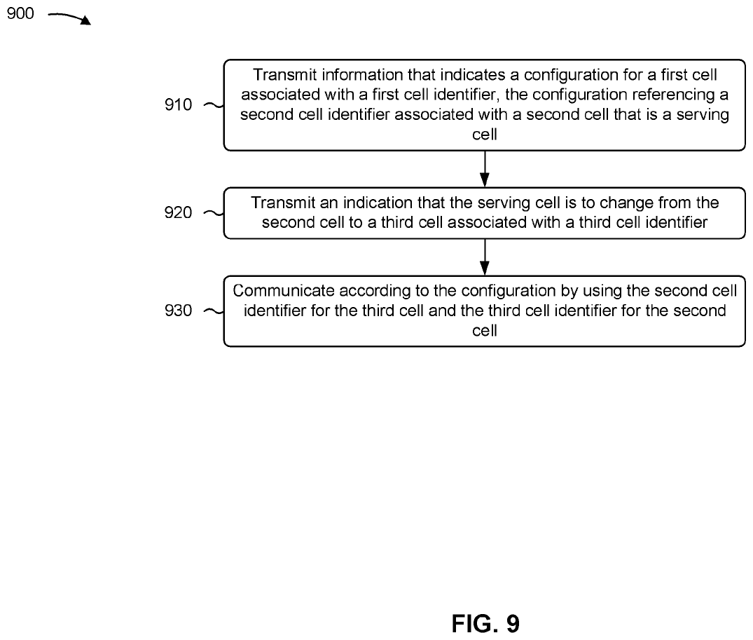

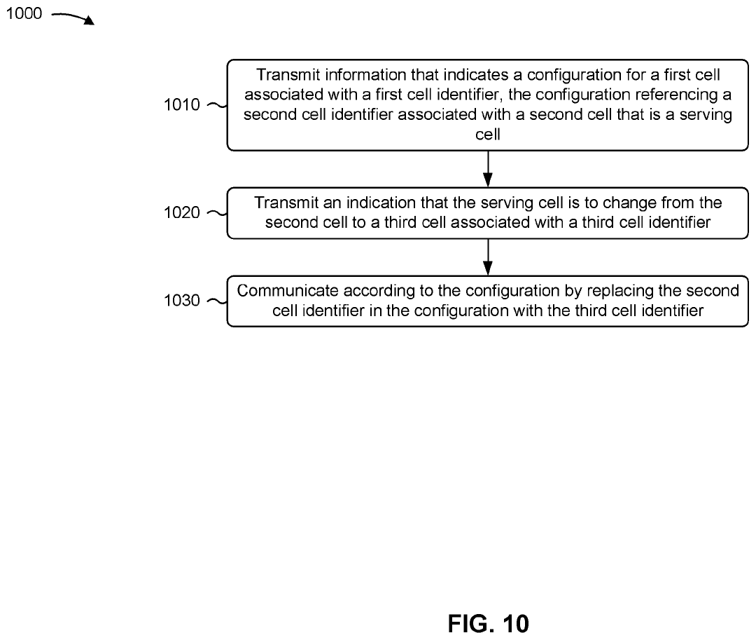

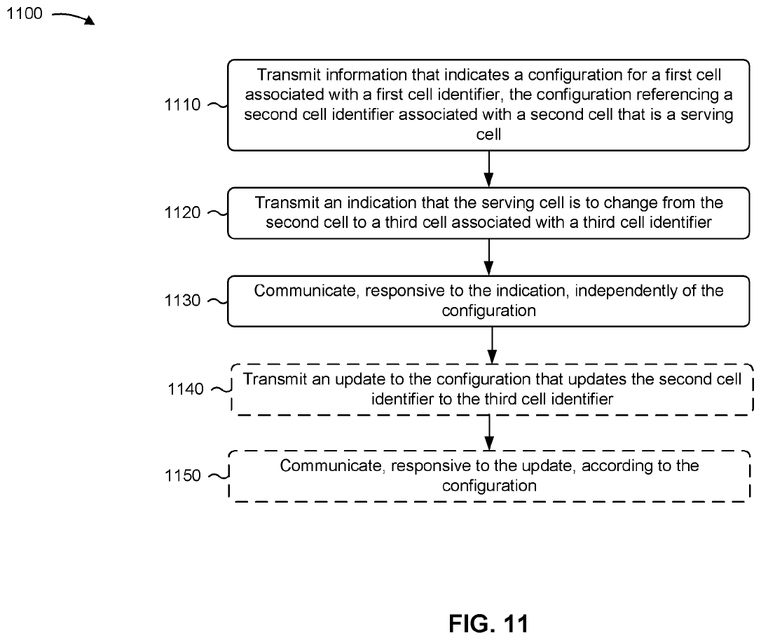

The controller/processor 240 of the network node 110, the controller/processor 280 of the UE 120, and/or any other component(s) of FIG. 2 may perform one or more techniques associated with communication using a cross-carrier configuration following a serving cell change, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, process 800 of FIG. 8, process 900 of FIG. 9, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, process 800 of FIG. 8, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving information that indicates a configuration for a first cell associated with a first cell identifier, the configuration referencing a second cell identifier associated with a second cell that is a serving cell; means for receiving an indication that the serving cell is to change from the second cell to a third cell associated with a third cell identifier; and/or means for communicating according to the configuration by using the second cell identifier for the third cell and the third cell identifier for the second cell. In some aspects, the UE includes means for receiving information that indicates a configuration for a first cell associated with a first cell identifier, the configuration referencing a second cell identifier associated with a second cell that is a serving cell; means for receiving an indication that the serving cell is to change from the second cell to a third cell associated with a third cell identifier; and/or means for communicating according to the configuration by replacing the second cell identifier in the configuration with the third cell identifier. In some aspects, the UE includes means for receiving information that indicates a configuration for a first cell associated with a first cell identifier, the configuration referencing a second cell identifier associated with a second cell that is a serving cell; means for receiving an indication that the serving cell is to change from the second cell to a third cell associated with a third cell identifier; and/or means for communicating, responsive to the indication, independently of the configuration. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting information that indicates a configuration for a first cell associated with a first cell identifier, the configuration referencing a second cell identifier associated with a second cell that is a serving cell; means for transmitting an indication that the serving cell is to change from the second cell to a third cell associated with a third cell identifier; and/or means for communicating according to the configuration by using the second cell identifier for the third cell and the third cell identifier for the second cell. In some aspects, the network node includes means for transmitting information that indicates a configuration for a first cell associated with a first cell identifier, the configuration referencing a second cell identifier associated with a second cell that is a serving cell; means for transmitting an indication that the serving cell is to change from the second cell to a third cell associated with a third cell identifier; and/or means for communicating according to the configuration by replacing the second cell identifier in the configuration with the third cell identifier. In some aspects, the network node includes means for transmitting information that indicates a configuration for a first cell associated with a first cell identifier, the configuration referencing a second cell identifier associated with a second cell that is a serving cell; means for transmitting an indication that the serving cell is to change from the second cell to a third cell associated with a third cell identifier; and/or means for communicating, responsive to the indication, independently of the configuration. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

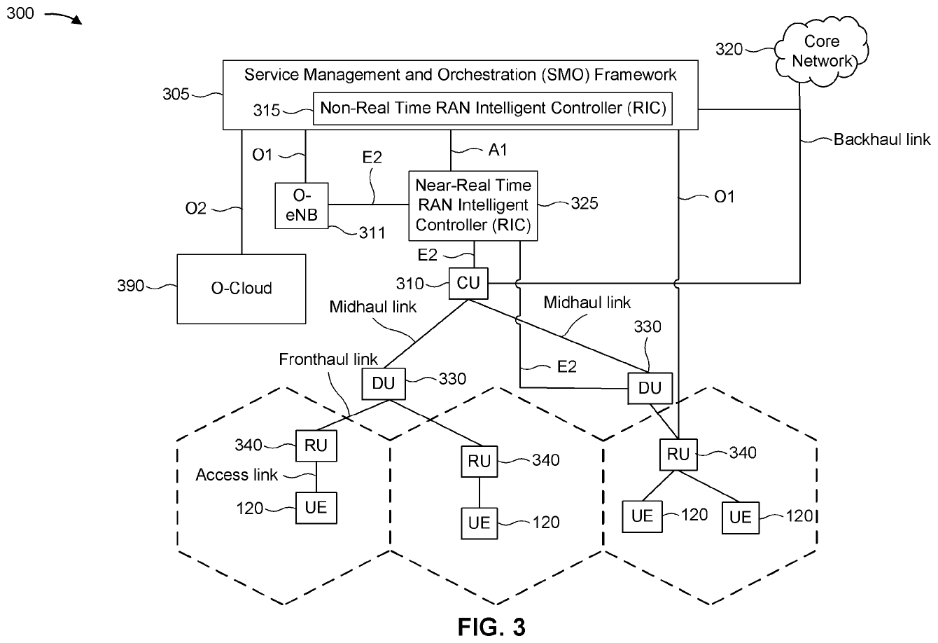

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325 The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

Carrier aggregation is a technology that enables two or more component carriers (CCs, sometimes referred to as carriers) to be combined (e.g., into a single channel) for a single UE to enhance data capacity. Carriers can be combined in the same or different frequency bands. Additionally, or alternatively, contiguous or non-contiguous carriers can be combined. A network node may configure carrier aggregation for a UE, such as in an RRC message, DCI, and/or another signaling message.

In carrier aggregation, a UE may be configured with a primary carrier or PCell and one or more secondary carriers or SCells. The PCell and SCell(s) may be serving cells for the UE. In some examples, one carrier may carry control information (e.g., DCI and/or scheduling information) for scheduling data communications on one or more secondary carriers, which may be referred to as “cross-carrier scheduling.” In some examples, a carrier (e.g., a primary carrier or a secondary carrier) may carry control information for scheduling data communications on the carrier, which may be referred to as “self-carrier scheduling” or “carrier self-scheduling.”

In layer (L1)/layer (L2) based mobility, L1 signaling and/or L2 signaling may be used to indicate a change of a serving cell (e.g., via a beam change signaling). L1 may refer to a PHY layer of a device, and L2 may refer to a MAC, RLC, and/or PDCP layer of a device. L1 signaling may include, for example, DCI, and L2 signaling may include, for example, a MAC control element (MAC-CE). Thus, a dynamic switching mechanism among candidate serving cells (e.g., including special cells (SPCells) and SCells) may be based on the L1/L2 signaling. In some examples, in carrier aggregation, separate signaling may be used for indicating a PCell change and for indicating an SCell change. For example, PCell selection may be beam indication based, and SCell selection may be based on L1/L2 signaling.

A UE 120 may be configured with a set of candidate PCells. Without carrier aggregation (or dual connectivity), a single PCell may be selected for the UE 120 among the configured set of candidate PCells. As the UE 120 moves closer to another cell, the UE 120 may receive, from a network node 110 an indication to change a PCell of the UE 120 from the old PCell to a new PCell (e.g., based on L1/L2 signaling).

In carrier aggregation, a PCell change may include swapping a PCell and an SCell among the configured set of candidate PCells. For example, in carrier aggregation, a UE 120 may communicate using a PCell and one or more SCells. As the UE 120 moves closer to an SCell, the UE 120 may receive, from a network node 110 an indication to change the SCell to a new PCell and the PCell to a new SCell.

In L1/L2 based mobility, the UE 120 may receive, from a network node, a configuration associated with a cell that includes a reference to a cell identifier associated with a switched cell. That is, the configuration may be a dependent, cross-carrier configuration that includes a reference to a cell identifier. After the cell is switched, the configuration may no longer be valid, thereby affecting the performance of communications of the UE 120.

Some techniques and apparatuses described herein improve communications of a UE when the UE receives, from a network node, a cross-carrier configuration that includes a reference to a cell identifier of a serving cell, and that reference to the cell identifier becomes invalid due to the UE subsequently receiving, from the network node, an indication to change from the serving cell (i.e., the original serving cell) to a new serving cell. For example, as described above, the UE may receive the indication responsive to the UE moving away from a coverage area of the original serving cell and to a coverage area of the new serving cell. In some aspects, based at least in part on the cross-carrier configuration having the invalid reference to the cell identifier of the original serving cell, the UE may communicate according to the cross-carrier configuration by using the cell identifier of the original serving cell for the new serving cell and a cell identifier of the new serving cell for the original serving cell (e.g., the cell identifiers of the original serving cell and the new serving cell are swapped). In other words, the UE may assume, in the absence of signaling from the network node to update the cross-carrier configuration, that a reference to the cell identifier of the original serving cell in the configuration is actually referencing the new serving cell. In this way, by assuming that the cross-carrier configuration is referencing a current serving cell of the UE (rather than a previous serving cell of the UE), the configuration remains valid, thereby improving the performance of communications of the UE following the change from the original serving cell to the new serving cell.

In some aspects, based at least in part on the cross-carrier configuration having the invalid reference to the cell identifier of the original serving cell, the UE may communicate according to the cross-carrier configuration by replacing the cell identifier of the original serving cell in the configuration with a cell identifier of the new serving cell. In other words, the UE may assume, in the absence of signaling from the network node to update the cross-carrier configuration, that a reference to the cell identifier of the original serving cell in the configuration is replaced with a reference to the cell identifier of the new serving cell. In this way, by assuming that the cross-carrier configuration is updated to reference a cell identifier of a current serving cell of the UE (rather than a previous serving cell of the UE), the configuration remains valid, thereby improving the performance of communications of the UE following the change from the original serving cell to the new serving cell.

In some aspects, based at least in part on the cross-carrier configuration having the invalid reference to the cell identifier of the original serving cell, the UE may communicate independently of the cross-carrier configuration (e.g., with the configuration suspended) until an update to the configuration is received by the UE. For example, the UE may use one or more default settings, instead of one or more settings indicated by the cross-carrier configuration, until an update to the configuration is received by the UE. In this way, the invalid reference in the cross-carrier configuration does not adversely affect the performance of communications of the UE following the change from the original serving cell to the new serving cell.

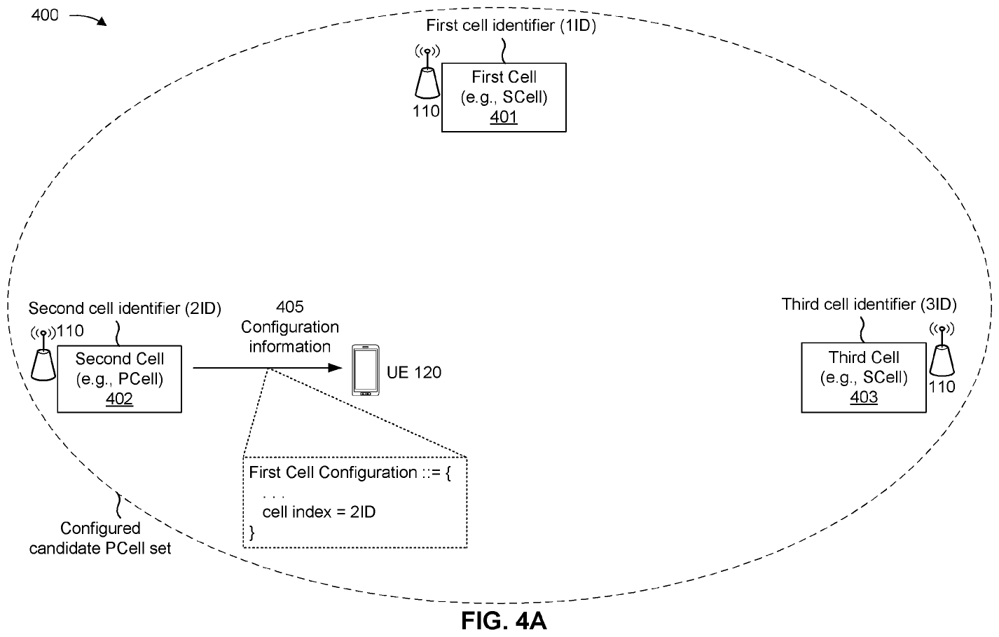

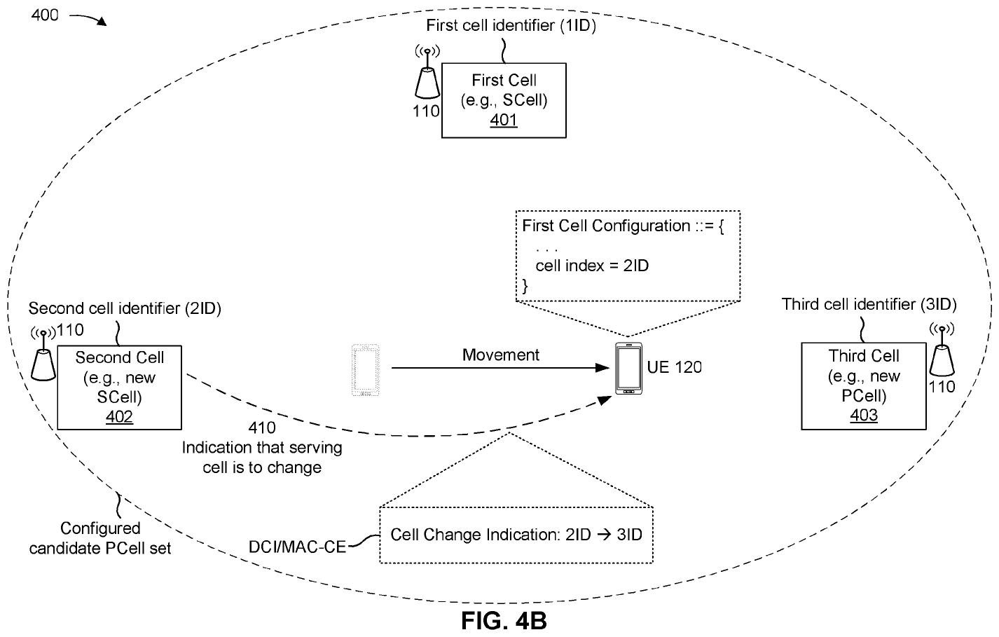

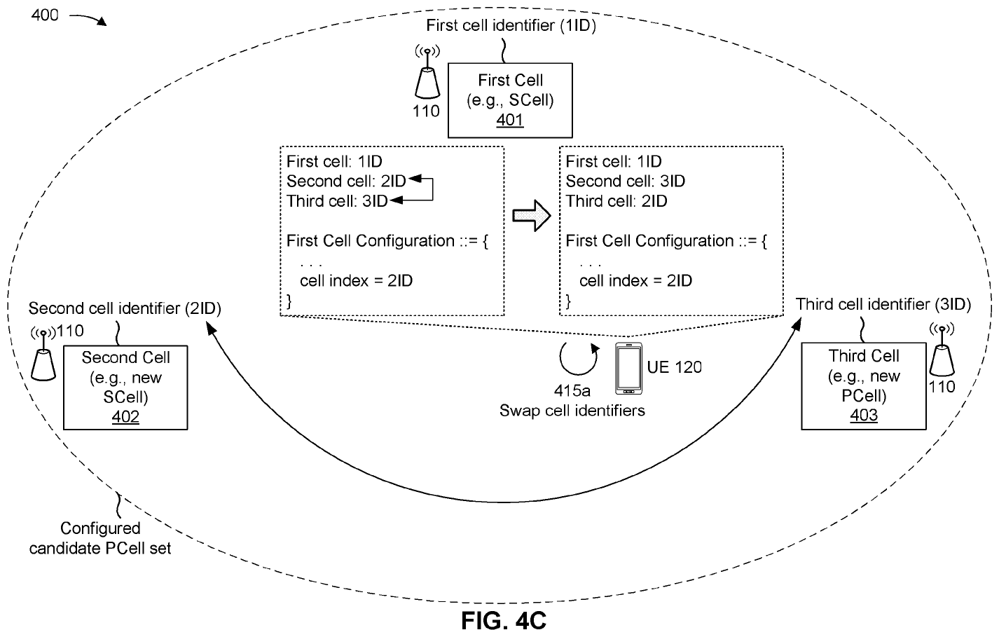

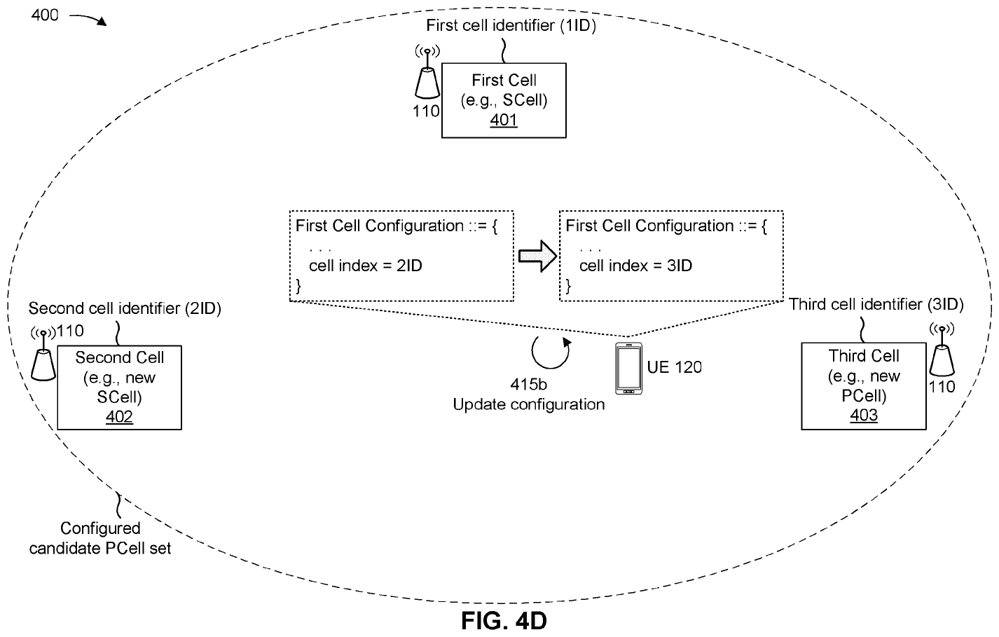

FIGS. 4A-4D are diagrams of an example 400 associated with communication using a cross-carrier configuration following a serving cell change, in accordance with the present disclosure.

FIGS. 4A-4D show a UE 120, a first cell 401, a second cell 402, and a third cell 403. The UE 120 may be configured (e.g., by a network node 110) with a candidate PCell set that includes the first cell 401, the second cell 402, and the third cell 403. As shown, the first cell 401 may be associated with a first cell identifier (1ID), the second cell 402 may be associated with a second cell identifier (2ID), and the third cell 403 may be associated with a third cell identifier (3ID). The first cell 401, the second cell 402, and the third cell 403 may be implemented by one or more network nodes 110. The first cell 401, the second cell 402, and the third cell 403 may be serving cells for the UE 120. For example, prior to operations shown in FIGS. 4A-4D, the first cell 401 and the third cell 403 may be SCells of the UE 120, and the second cell 402 may be a PCell of the UE 120.

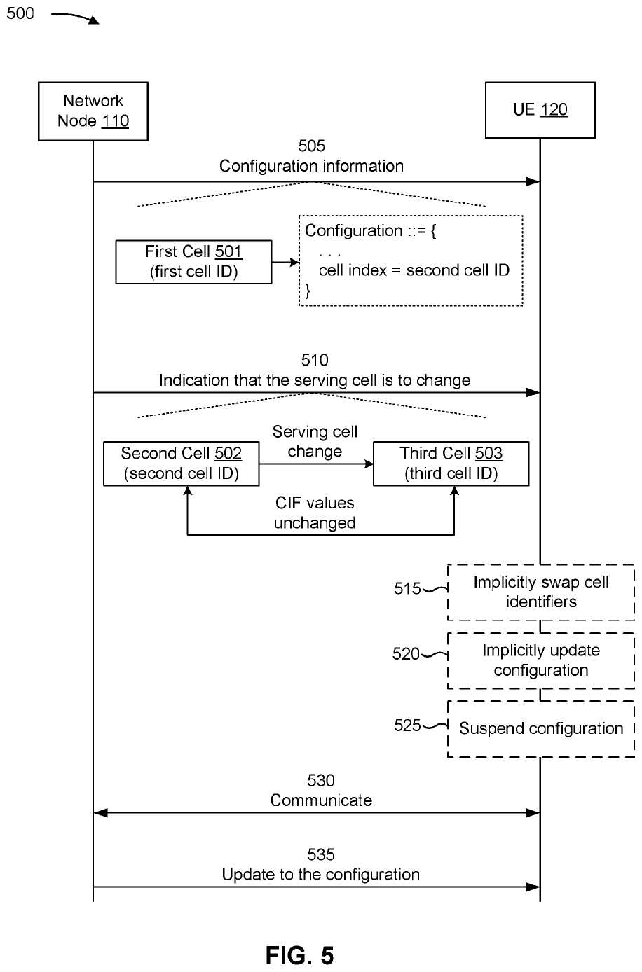

As shown in FIG. 4A, and by reference number 405, the UE 120 may receive (e.g., on the first cell 401 and/or the second cell 402), configuration information indicating a configuration for the first cell 401, as described further in connection with FIG. 5. For example, the configuration for the first cell 401 may reference the second cell identifier associated with the second cell 402.

As shown in FIG. 4B, the UE 120 may move away from a coverage area associated with the second cell 402 (e.g., to, or beyond, an edge of the second cell 402). As shown by reference number 410, based at least in part on the movement of the UE 120, the UE 120 may receive (e.g., on the first cell 401 and/or the second cell 402), an indication that a serving cell for the UE 120 is to change from the second cell 402 to the third cell 403, as described further in connection with FIG. 5. Thus, for example, the third cell 403 may become a new PCell for the UE 120, and the second cell 402 may become a new SCell for the UE 120 following the change of the serving cell. The indication may be by L1 or L2 signaling, such as by DCI or a MAC-CE, as shown. For example, the DCI or MAC-CE may include a cell change indication (e.g., a beam switching indication).

As shown in FIG. 4C, and by reference number 415a, in some aspects, the UE 120 may swap the cell identifiers for the second cell 402 and the third cell 403, as described further in connection with FIG. 5. That is, the UE 120 may use the third cell identifier for the second cell 402 and the second cell identifier for the third cell 403. In this way, by assuming that the reference to the second cell identifier in the configuration is referencing the third cell 403 (rather than the second cell 402), the configuration remains valid.

As shown in FIG. 4D, and by reference number 415b, in some aspects, the UE 120 may update the configuration by replacing the second cell identifier with the third cell identifier, as described further in connection with FIG. 5. In this way, by assuming that the configuration is referencing the third cell identifier of the third cell 403 (rather than the second cell identifier of the second cell 402), the configuration remains valid.

As indicated above, FIGS. 4A-4D are provided as examples. Other examples may differ from what is described with regard to FIGS. 4A-4D.

FIG. 5 is a diagram of an example 500 associated with communication using a cross-carrier configuration following a serving cell change, in accordance with the present disclosure. As shown in FIG. 5, a network node 110 (e.g., a CU, a DU, and/or an RU) may communicate with a UE 120. In some aspects, the network node 110 and the UE 120 may be part of a wireless network (e.g., wireless network 100). The UE 120 and the network node 110 may have established a wireless connection prior to operations shown in FIG. 5. In some aspects, operations described as being performed by the network node 110 may be performed by multiple network nodes 110. For example, configuration operations may be performed by a first network node 110 (e.g., a CU or a DU) and radio communication operations may be performed by a second network node 110 (e.g., an RU).

As shown by reference number 505, the network node 110 may transmit, and the UE 120 may receive, configuration information. In some aspects, the UE 120 may receive the configuration information via one or more of RRC signaling, one or more MAC-CEs, and/or DCI, among other examples. In some aspects, the configuration information may include an indication of one or more configuration parameters (e.g., already known to the UE 120 and/or previously indicated by the network node 110 or another network device) for selection by the UE 120, and/or explicit configuration information for the UE 120 to use to configure the UE 120, among other examples.

In some aspects, the configuration information may indicate a configuration for a first cell 501 associated with a first cell identifier. The first cell 501 may be a current SCell for the UE 120. The configuration may be a cross-carrier configuration that includes a reference to another cell. For example, the configuration for the first cell 501 may reference a second cell identifier (e.g., a serving cell identifier) associated with a second cell 502. The second cell 502 may be a current serving cell (e.g., a PCell) for the UE 120.

In some aspects, the configuration may include a cross-carrier scheduling configuration (e.g., CrossCarrierSchedulingConfig) for the first cell. Here, the first cell 501 may be a scheduled cell for cross-carrier scheduling and the second cell 502 may be a scheduling cell for cross-carrier scheduling. For example, the cross-carrier scheduling configuration may include a parameter (e.g., cif-Presence) indicating whether a carrier indicator field (CIF) is to be present in DCI, a parameter (e.g., schedulingCellId) indicating a cell identifier of a scheduling cell (e.g., ServCellIndex) for cross-carrier scheduling, and/or a parameter (e.g., cif-InSchedulingCell) indicating a CIF value that indicates scheduling for the scheduled cell. Thus, the cell identifier of the scheduling cell in the cross-carrier scheduling configuration may be the second cell identifier of the second cell 502.

Additionally, or alternatively, the configuration may include a transmission configuration indicator (TCI) configuration for the first cell 501. For example, the TCI configuration may include a TCI state parameter (e.g., TCI-State) that references a quasi-co-location (QCL) information parameter (e.g., QCL-Info), and the QCL information parameter may indicate a cell identifier of a serving cell (e.g., ServCellIndex). The TCI configuration may also indicate a QCL type. Thus, the cell identifier of the serving cell in the TCI configuration may be the second cell identifier of the second cell 502. A TCI state may indicate a directionality or a characteristic of a beam, such as one or more QCL properties of the beam. A QCL property may include, for example, a Doppler shift, a Doppler spread, an average delay, a delay spread, or spatial receive parameters, among other examples.

Additionally, or alternatively, the configuration may include a path loss reference signal (PLRS) configuration (e.g., PLRS-config) for the first cell 501. For example, the PLRS configuration may include a parameter that indicates a cell identifier of a cell on which a PLRS is to be measured and a parameter that indicates a reference signal identifier for a reference signal that is to be used for a PLRS. Thus, the cell identifier of the cell in the PLRS configuration may be the second cell identifier of the second cell 502. “PLRS” may refer to a reference signal that is indicated for, or otherwise used for, path loss estimation.

Additionally, or alternatively, the configuration may include a channel state information (CSI) report configuration (e.g., CSI-report-config) for the first cell 501. For example, the CSI report configuration may include a parameter that indicates a cell identifier of a cell on which measurements for the CSI report are to be taken. Thus, the cell identifier of the cell in the CSI report configuration may be the second cell identifier of the second cell 502. In connection with the CSI report configuration, a cell identifier may be configured with channel measurement resources or a trigger state for semi-persistent CSI or aperiodic CSI. “CSI report” or “CSI feedback” may refer to a report of CSI for a cell that is provided by a UE. CSI may include a channel quality indicator (CQI), a precoding matrix indicator (PMI), a rank indicator (RI), or the like.

Additionally, or alternatively, the configuration may include a physical uplink control channel (PUCCH) cell configuration for the first cell 501. For example, the PUCCH cell configuration may include a parameter that indicates a cell identifier of a cell that is to be a PUCCH cell. Thus, the cell identifier of the cell in the PUCCH cell configuration may be the second cell identifier of the second cell 502. “PUCCH cell” may refer to a cell on which PUCCH communications are allowed.

The UE 120 may configure itself based at least in part on the configuration information. In some aspects, the UE 120 may be configured to perform one or more operations described herein based at least in part on the configuration information.

As shown by reference number 510, the network node 110 may transmit, and the UE 120 may receive, an indication that the serving cell for the UE 120 is to change from the second cell 502 (associated with the second cell identifier) to a third cell 503 associated with a third cell identifier (e.g., a serving cell identifier). The third cell 503 may be a current (prior to the indication) SCell for the UE 120 and/or a candidate PCell for the UE 120. For example, the indication may indicate that a PCell for the UE 120 is to change from the second cell 502 to the third cell 503. The indication may be a dynamic indication. That is, the indication may be in connection with layer 1 (L1) or layer 2 (L2) based mobility (e.g., inter-cell mobility) signaling. For example, the indication may be in one of DCI or a MAC-CE. The UE 120 may receive the indication in connection with a UE mobility scenario (e.g., where the UE 120 is moving between coverage areas).

Accordingly, the indication to change from the second cell 502 to the third cell 503 results in a scenario in which a candidate cell (the third cell 503) is selected as a new cell to switch to from an old cell (the second cell 502), and there is an additional cell (the first cell 501) with a cross-carrier configuration that includes a cell identifier of the old cell. In other words, changing from the second cell 502 to the third cell 503 results in the configuration having an outdated reference to the second cell identifier. Thus, the cross-carrier configuration is a dependent cross-carrier configuration that should be updated to maintain the validity of the configuration. In some aspects, where the configuration is a cross-carrier scheduling configuration, the old cell (the second cell 502) is a scheduling cell and the additional cell (the first cell 501) is a scheduled cell.

As shown by reference number 515, responsive to the indication (e.g., in order to update the dependent cross-carrier configuration), the UE 120 may implicitly swap the third cell identifier (the new cell identifier) and the second cell identifier (the old cell identifier) by using the second cell identifier for the third cell and the third cell identifier for the second cell. In other words, the UE 120 may use an assumption that the third cell 503 is associated with the second cell identifier and that the second cell 502 is associated with the third cell identifier. For example, if the second cell 502 was the PCell associated with a cell identifier of 0, then the cell identifier for the third cell 503, after swapping cell identifiers, is 0. In this way, the configuration for the first cell 501 remains valid. For example, a cross-carrier scheduling configuration for the first cell 501 (e.g., a scheduled cell) remains valid. In some aspects, CIF values used in the second cell 502 may be maintained in the third cell 503. That is, a set of values (e.g., one or more values) that are usable for a CIF in DCI are unchanged by the serving cell changing from the second cell 502 to the third cell 503. In some aspects, the network node 110 may also implicitly swap the cell identifiers by using the second cell identifier for the third cell and the third cell identifier for the second cell, in a similar manner as described above.

Alternatively, as shown by reference number 520, responsive to the indication (e.g., in order to update the dependent cross-carrier configuration), the UE 120 may implicitly update the configuration for the first cell 501 by replacing the second cell identifier (the old cell identifier) in the configuration with the third cell identifier (the new cell identifier). In other words, the UE 120 may use an assumption that the second cell identifier in the configuration is replaced with the third cell identifier. In some aspects, the network node 110 may also implicitly update the configuration by replacing the second cell identifier in the configuration with the third cell identifier, in a similar manner as described above.

Alternatively, as shown by reference number 525, responsive to the indication, the UE 120 may suspend the configuration for the first cell. The UE 120 may suspend the configuration until the UE 120 receives new signaling (e.g., mapping signaling) that updates the configuration (e.g., RRC signaling or a MAC-CE may update a cell identifier in the configuration for the cell). In some aspects, the network node 110 may also suspend the configuration for the first cell.

As shown by reference number 530, the UE 120 may communicate and/or the network node 110 may communicate (e.g., with each other). For example, the UE 120 may communicate and/or the network node 110 may communicate (e.g., on the first cell 501) according to the configuration by using the second cell identifier for the third cell and the third cell identifier for the second cell (e.g., the cell identifiers of the second cell 502 and the third cell 503 are implicitly swapped). In this way, the configuration remains valid following the change of the serving cell. As another example, the UE 120 may communicate and/or the network node 110 may communicate (e.g., on the first cell 501) according to the configuration by replacing (e.g., implicitly replacing) the second cell identifier in the configuration with the third cell identifier (e.g., the configuration is implicitly updated from the second cell identifier to the third cell identifier). In this way, the configuration is implicitly updated to a valid state following the change of the serving cell.

As an additional example, the UE 120 may communicate and/or the network node 110 may communicate (e.g., on the first cell 501) independently of the configuration (e.g., without using the settings of the configuration). For example, the UE 120 may communicate and/or the network node 110 may communicate (e.g., on the first cell 501) with the configuration for the first cell 501 suspended. Suspending the configuration may include ignoring the configuration (e.g., by using default settings for parameters of the configuration rather than the settings indicated by the configuration). In this way, the outdated reference in the configuration does not adversely affect communications following the change of the serving cell.

As shown by reference number 535, the network node 110 may transmit, and the UE 120 may receive, an update (e.g., signaling indicating an update) to the configuration for the first cell 501. The update may update the second cell identifier referenced in the configuration to the third cell identifier. The update may be in one of RRC signaling or a MAC-CE. Responsive to the update, the UE 120 may communicate and/or the network node may communicate (e.g., on the first cell 501) according to the configuration. For example, the suspension of the configuration may be lifted responsive to the update.

In this way, techniques described herein resolve an outdated reference to a cell identifier in a cross-carrier configuration. Accordingly, the performance of communications is improved following a change of a serving cell.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 120) performs operations associated with communication using a cross-carrier configuration following a serving cell change.

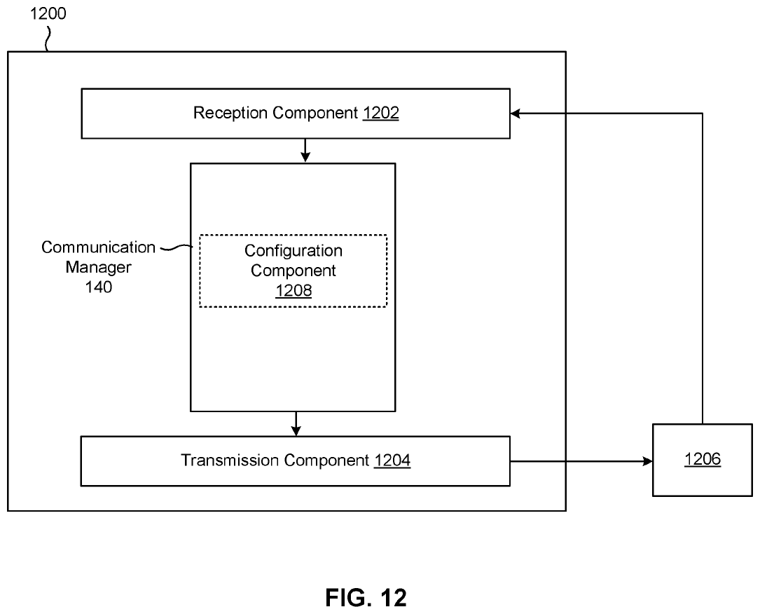

As shown in FIG. 6, in some aspects, process 600 may include receiving (e.g., obtaining) information that indicates a configuration for a first cell associated with a first cell identifier, the configuration referencing a second cell identifier associated with a second cell that is a serving cell (block 610). For example, the UE (e.g., using communication manager 140 and/or reception component 1202, depicted in FIG. 12) may receive information that indicates a configuration for a first cell associated with a first cell identifier, the configuration referencing a second cell identifier associated with a second cell that is a serving cell, as described above.

As further shown in FIG. 6, in some aspects, process 600 may include receiving (e.g., obtaining) an indication that the serving cell is to change from the second cell to a third cell associated with a third cell identifier (block 620). For example, the UE (e.g., using communication manager 140 and/or reception component 1202, depicted in FIG. 12) may receive an indication that the serving cell is to change from the second cell to a third cell associated with a third cell identifier, as described above.

As further shown in FIG. 6, in some aspects, process 600 may include communicating (e.g., obtaining, providing, and/or outputting) according to the configuration by using the second cell identifier for the third cell and the third cell identifier for the second cell (block 630). For example, the UE (e.g., using communication manager 140, reception component 1202, and/or transmission component 1204, depicted in FIG. 12) may communicate according to the configuration by using the second cell identifier for the third cell and the third cell identifier for the second cell, as described above.

Process 600 may include additional aspects, such as any single aspect or any combination of aspects described below and/or in connection with one or more other processes described elsewhere herein.

In a first aspect, the configuration includes at least one of a cross-carrier scheduling configuration, a transmission configuration indicator configuration, a path loss reference signal configuration, a channel state information report configuration, or a physical uplink control channel cell configuration.

In a second aspect, alone or in combination with the first aspect, a set of values that are usable for a carrier indicator field in downlink control information are unchanged by the serving cell changing from the second cell to the third cell.

In a third aspect, alone or in combination with one or more of the first and second aspects, the serving cell is a primary cell.

In a fourth aspect, alone or in combination with one or more of the first through third aspects, the indication is in one of downlink control information or a MAC-CE.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a UE, in accordance with the present disclosure. Example process 700 is an example where the UE (e.g., UE 120) performs operations associated with communication using a cross-carrier configuration following a serving cell change.

As shown in FIG. 7, in some aspects, process 700 may include receiving (e.g., obtaining) information that indicates a configuration for a first cell associated with a first cell identifier, the configuration referencing a second cell identifier associated with a second cell that is a serving cell (block 710). For example, the UE (e.g., using communication manager 140 and/or reception component 1202, depicted in FIG. 12) may receive information that indicates a configuration for a first cell associated with a first cell identifier, the configuration referencing a second cell identifier associated with a second cell that is a serving cell, as described above.

As further shown in FIG. 7, in some aspects, process 700 may include receiving (e.g., obtaining) an indication that the serving cell is to change from the second cell to a third cell associated with a third cell identifier (block 720). For example, the UE (e.g., using communication manager 140 and/or reception component 1202, depicted in FIG. 12) may receive an indication that the serving cell is to change from the second cell to a third cell associated with a third cell identifier, as described above.

As further shown in FIG. 7, in some aspects, process 700 may include communicating (e.g., obtaining, providing, and/or outputting) according to the configuration by replacing the second cell identifier in the configuration with the third cell identifier (block 730). For example, the UE (e.g., using communication manager 140, reception component 1202, and/or transmission component 1204, depicted in FIG. 12) may communicate according to the configuration by replacing the second cell identifier in the configuration with the third cell identifier, as described above.

Process 700 may include additional aspects, such as any single aspect or any combination of aspects described below and/or in connection with one or more other processes described elsewhere herein.

In a first aspect, the configuration includes at least one of a cross-carrier scheduling configuration, a transmission configuration indicator configuration, a path loss reference signal configuration, a channel state information report configuration, or a physical uplink control channel cell configuration.

In a second aspect, alone or in combination with the first aspect, the serving cell is a primary cell.

In a third aspect, alone or in combination with one or more of the first and second aspects, the indication is in one of downlink control information or a MAC-CE.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120) performs operations associated with communication using a cross-carrier configuration following a serving cell change. Operations that may be optional are indicated by dashed lines.

As shown in FIG. 8, in some aspects, process 800 may include receiving (e.g., obtaining) information that indicates a configuration for a first cell associated with a first cell identifier, the configuration referencing a second cell identifier associated with a second cell that is a serving cell (block 810). For example, the UE (e.g., using communication manager 140 and/or reception component 1202, depicted in FIG. 12) may receive information that indicates a configuration for a first cell associated with a first cell identifier, the configuration referencing a second cell identifier associated with a second cell that is a serving cell, as described above.

As further shown in FIG. 8, in some aspects, process 800 may include receiving (e.g., obtaining) an indication that the serving cell is to change from the second cell to a third cell associated with a third cell identifier (block 820). For example, the UE (e.g., using communication manager 140 and/or reception component 1202, depicted in FIG. 12) may receive an indication that the serving cell is to change from the second cell to a third cell associated with a third cell identifier, as described above.

As further shown in FIG. 8, in some aspects, process 800 may include communicating (e.g., obtaining, providing, and/or outputting), responsive to the indication, independently of the configuration (block 830). For example, the UE (e.g., using communication manager 140, reception component 1202, and/or transmission component 1204, depicted in FIG. 12) may communicate, responsive to the indication, independently of the configuration, as described above.

In some aspects, process 800 may include receiving (e.g., obtaining) an update to the configuration that updates the second cell identifier to the third cell identifier (block 840). For example, the UE (e.g., using communication manager 140 and/or reception component 1202, depicted in FIG. 12) may receive an update to the configuration that updates the second cell identifier to the third cell identifier, as described above.

In some aspects, process 800 may include communicating (e.g., obtaining, providing, and/or outputting), responsive to the update, according to the configuration (block 850). For example, the UE (e.g., using communication manager 140, reception component 1202, and/or transmission component 1204, depicted in FIG. 12) may communicate, responsive to the update, according to the configuration, as described above.

Process 800 may include additional aspects, such as any single aspect or any combination of aspects described below and/or in connection with one or more other processes described elsewhere herein.

In a first aspect, the configuration includes at least one of a cross-carrier scheduling configuration, a transmission configuration indicator configuration, a path loss reference signal configuration, a channel state information report configuration, or a physical uplink control channel cell configuration.

In a second aspect, alone or in combination with the first aspect, process 800 includes receiving an update to the configuration that updates the second cell identifier to the third cell identifier, and communicating, responsive to the update, according to the configuration.

In a third aspect, alone or in combination with one or more of the first and second aspects, the update is in one of radio resource control signaling or a MAC-CE.

In a fourth aspect, alone or in combination with one or more of the first through third aspects, the serving cell is a primary cell.

In a fifth aspect, alone or in combination with one or more of the first through fourth aspects, the indication is in one of downlink control information or a MAC-CE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with communication using a cross-carrier configuration following a serving cell change. Operations that may be optional are indicated by dashed lines.

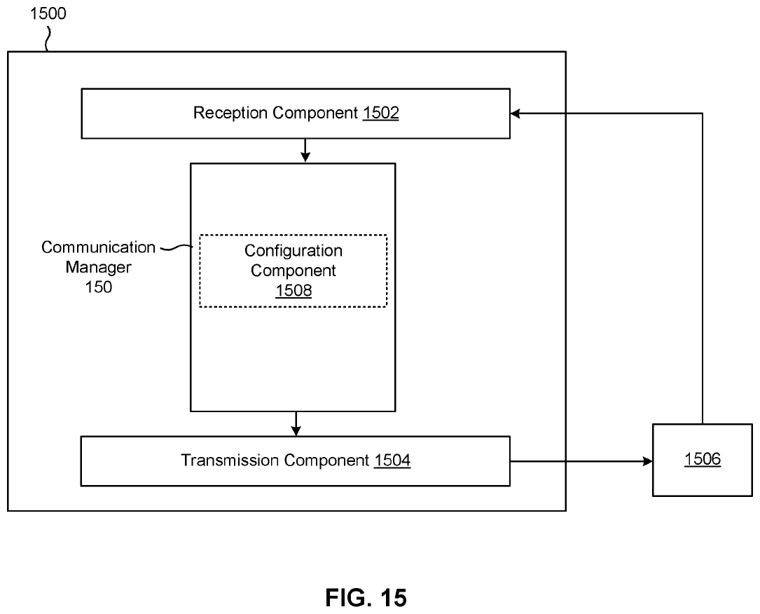

As shown in FIG. 9, in some aspects, process 900 may include transmitting (e.g., providing and/or outputting) information that indicates a configuration for a first cell associated with a first cell identifier, the configuration referencing a second cell identifier associated with a second cell that is a serving cell (block 910). For example, the network node (e.g., using communication manager 150 and/or transmission component 1504, depicted in FIG. 15), such as a CU, a DU, or an RU, may transmit information that indicates a configuration for a first cell associated with a first cell identifier, the configuration referencing a second cell identifier associated with a second cell that is a serving cell, as described above.

As further shown in FIG. 9, in some aspects, process 900 may include transmitting (e.g., providing and/or outputting) an indication that the serving cell is to change from the second cell to a third cell associated with a third cell identifier (block 920). For example, the network node (e.g., using communication manager 150 and/or transmission component 1504, depicted in FIG. 15), such as a CU, a DU, or an RU, may transmit an indication that the serving cell is to change from the second cell to a third cell associated with a third cell identifier, as described above.

As further shown in FIG. 9, in some aspects, process 900 may include communicating (e.g., obtaining, providing, and/or outputting) according to the configuration by using the second cell identifier for the third cell and the third cell identifier for the second cell (block 930). For example, the network node (e.g., using communication manager 150, reception component 1502, and/or transmission component 1504, depicted in FIG. 15), such as a CU or a DU, may communicate according to the configuration by using the second cell identifier for the third cell and the third cell identifier for the second cell, as described above.

Process 900 may include additional aspects, such as any single aspect or any combination of aspects described below and/or in connection with one or more other processes described elsewhere herein.

In a first aspect, the configuration includes at least one of a cross-carrier scheduling configuration, a transmission configuration indicator configuration, a path loss reference signal configuration, a channel state information report configuration, or a physical uplink control channel cell configuration.

In a second aspect, alone or in combination with the first aspect, a set of values that are usable for a carrier indicator field in downlink control information are unchanged by the serving cell changing from the second cell to the third cell.

In a third aspect, alone or in combination with one or more of the first and second aspects, the serving cell is a primary cell.

In a fourth aspect, alone or in combination with one or more of the first through third aspects, the indication is in one of downlink control information or a MAC-CE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with communication using a cross-carrier configuration following a serving cell change.

As shown in FIG. 10, in some aspects, process 1000 may include transmitting (e.g., providing and/or outputting) information that indicates a configuration for a first cell associated with a first cell identifier, the configuration referencing a second cell identifier associated with a second cell that is a serving cell (block 1010). For example, the network node (e.g., using communication manager 150 and/or transmission component 1504, depicted in FIG. 15), such as a CU, a DU, or an RU, may transmit information that indicates a configuration for a first cell associated with a first cell identifier, the configuration referencing a second cell identifier associated with a second cell that is a serving cell, as described above.

As further shown in FIG. 10, in some aspects, process 1000 may include transmitting (e.g., providing and/or outputting) an indication that the serving cell is to change from the second cell to a third cell associated with a third cell identifier (block 1020). For example, the network node (e.g., using communication manager 150 and/or transmission component 1504, depicted in FIG. 15), such as a CU, a DU, or an RU, may transmit an indication that the serving cell is to change from the second cell to a third cell associated with a third cell identifier, as described above.

As further shown in FIG. 10, in some aspects, process 1000 may include communicating (e.g., obtaining, providing, and/or outputting) according to the configuration by replacing the second cell identifier in the configuration with the third cell identifier (block 1030). For example, the network node (e.g., using communication manager 150, reception component 1502, and/or transmission component 1504, depicted in FIG. 15), such as a CU or a DU, may communicate according to the configuration by replacing the second cell identifier in the configuration with the third cell identifier, as described above.

Process 1000 may include additional aspects, such as any single aspect or any combination of aspects described below and/or in connection with one or more other processes described elsewhere herein.

In a first aspect, the configuration includes at least one of a cross-carrier scheduling configuration, a transmission configuration indicator configuration, a path loss reference signal configuration, a channel state information report configuration, or a physical uplink control channel cell configuration.

In a second aspect, alone or in combination with the first aspect, the serving cell is a primary cell.

In a third aspect, alone or in combination with one or more of the first and second aspects, the indication is in one of downlink control information or a MAC-CE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with communication using a cross-carrier configuration following a serving cell change.

As shown in FIG. 11, in some aspects, process 1100 may include transmitting (e.g., providing and/or outputting) information that indicates a configuration for a first cell associated with a first cell identifier, the configuration referencing a second cell identifier associated with a second cell that is a serving cell (block 1110). For example, the network node (e.g., using communication manager 150 and/or transmission component 1504, depicted in FIG. 15), such as CU, a DU, or an RU, may transmit information that indicates a configuration for a first cell associated with a first cell identifier, the configuration referencing a second cell identifier associated with a second cell that is a serving cell, as described above.

As further shown in FIG. 11, in some aspects, process 1100 may include transmitting (e.g., providing and/or outputting) an indication that the serving cell is to change from the second cell to a third cell associated with a third cell identifier (block 1120). For example, the network node (e.g., using communication manager 150 and/or transmission component 1504, depicted in FIG. 15), such as a CU, a DU, or an RU, may transmit an indication that the serving cell is to change from the second cell to a third cell associated with a third cell identifier, as described above.

As further shown in FIG. 11, in some aspects, process 1100 may include communicating (e.g., obtaining, providing, and/or outputting), responsive to the indication, independently of the configuration (block 1130). For example, the network node (e.g., using communication manager 150, reception component 1502, and/or transmission component 1504, depicted in FIG. 15), such as a CU or a DU, may communicate, responsive to the indication, independently of the configuration, as described above.

In some aspects, process 1100 may include transmitting (e.g., providing and/or outputting) an update to the configuration that updates the second cell identifier to the third cell identifier (block 1140). For example, the network node (e.g., using communication manager 150 and/or transmission component 1504, depicted in FIG. 15), such as CU, a DU, or an RU, may transmit an update to the configuration that updates the second cell identifier to the third cell identifier, as described above.

In some aspects, process 1100 may include communicating (e.g., obtaining, providing, and/or outputting), responsive to the update, according to the configuration (block 1150). For example, the network node (e.g., using communication manager 150, reception component 1502, and/or transmission component 1504, depicted in FIG. 15), such as a CU or a DU, may communicate, responsive to the update, according to the configuration, as described above.

Process 1100 may include additional aspects, such as any single aspect or any combination of aspects described below and/or in connection with one or more other processes described elsewhere herein.

In a first aspect, the configuration includes at least one of a cross-carrier scheduling configuration, a transmission configuration indicator configuration, a path loss reference signal configuration, a channel state information report configuration, or a physical uplink control channel cell configuration.

In a second aspect, alone or in combination with the first aspect, process 1100 includes transmitting an update to the configuration that updates the second cell identifier to the third cell identifier, and communicating, responsive to the update, according to the configuration.

In a third aspect, alone or in combination with one or more of the first and second aspects, the update is in one of radio resource control signaling or a MAC-CE.

In a fourth aspect, alone or in combination with one or more of the first through third aspects, the serving cell is a primary cell.

In a fifth aspect, alone or in combination with one or more of the first through fourth aspects, the indication is in one of downlink control information or a MAC-CE.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a network node, or another wireless communication device) using the reception component 1202 and the transmission component 1204. As further shown, the apparatus 1200 may include the communication manager 140. The communication manager 140 may include a configuration component 1208, among other examples.

In some aspects, the apparatus 1200 may be configured to perform one or more operations described herein in connection with FIGS. 4A-4D and 5. Additionally, or alternatively, the apparatus 1200 may be configured to perform one or more processes described herein, such as process 600 of FIG. 6, process 700 of FIG. 7, process 800 of FIG. 8, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive information that indicates a configuration for a first cell associated with a first cell identifier, the configuration referencing a second cell identifier associated with a second cell that is a serving cell. The reception component 1202 may receive an indication that the serving cell is to change from the second cell to a third cell associated with a third cell identifier.

In some aspects, the configuration component 1208 may implicitly swap the third cell identifier and the second cell identifier by using the second cell identifier for the third cell and the third cell identifier for the second cell. The reception component 1202 and/or the transmission component 1204 may communicate according to the configuration by using the second cell identifier for the third cell and the third cell identifier for the second cell.

In some aspects, the configuration component 1208 may implicitly update the configuration for the first cell by replacing the second cell identifier in the configuration with the third cell identifier. The reception component 1202 and/or the transmission component 1204 may communicate according to the configuration by replacing the second cell identifier in the configuration with the third cell identifier.

In some aspects, the configuration component 1208 may suspend the configuration. The reception component 1202 and/or the transmission component 1204 may communicate, responsive to the indication, independently of the configuration. The reception component 1202 may receive an update to the configuration that updates the second cell identifier to the third cell identifier. The reception component 1202 and/or the transmission component 1204 may communicate, responsive to the update, according to the configuration.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

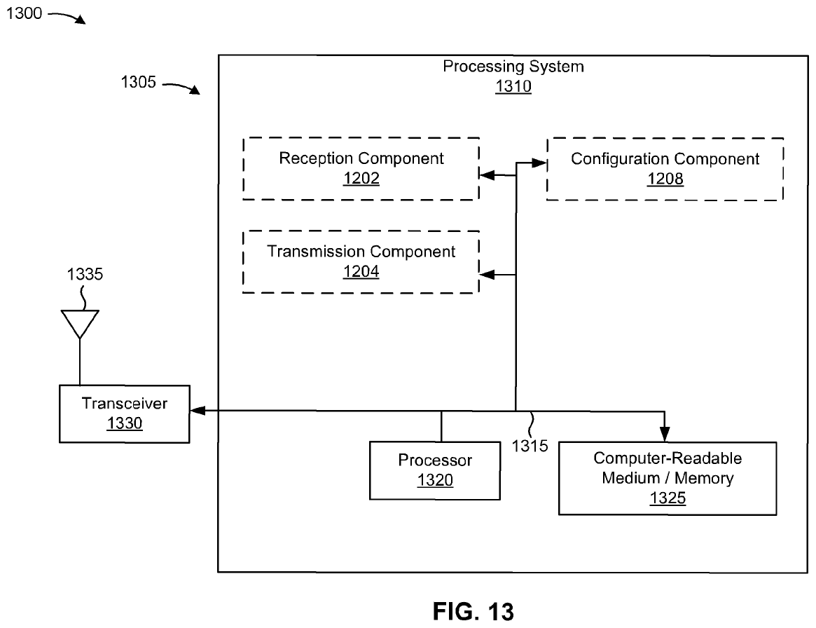

FIG. 13 is a diagram illustrating an example 1300 of a hardware implementation for an apparatus 1305 employing a processing system 1310, in accordance with the present disclosure. The apparatus 1305 may be a UE.

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors and/or hardware components, represented by the processor 1320, the illustrated components, and the computer-readable medium/memory 1325. The bus 1315 may also link various other circuits, such as timing sources, peripherals, voltage regulators, and/or power management circuits.

The processing system 1310 may be coupled to a transceiver 1330. The transceiver 1330 is coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1202. In addition, the transceiver 1330 receives information from the processing system 1310, specifically the transmission component 1204, and generates a signal to be applied to the one or more antennas 1335 based at least in part on the received information.

The processing system 1310 includes a processor 1320 coupled to a computer-readable medium/memory 1325. The processor 1320 is responsible for general processing, including the execution of software stored on the computer-readable medium/memory 1325. The software, when executed by the processor 1320, causes the processing system 1310 to perform the various functions described herein for any particular apparatus. The computer-readable medium/memory 1325 may also be used for storing data that is manipulated by the processor 1320 when executing software. The processing system further includes at least one of the illustrated components. The components may be software modules running in the processor 1320, resident/stored in the computer readable medium/memory 1325, one or more hardware modules coupled to the processor 1320, or some combination thereof.

In some aspects, the processing system 1310 may be a component of the UE 120 and may include the memory 282 and/or at least one of the TX MIMO processor 266, the receive processor 258, and/or the controller/processor 280. In some aspects, the apparatus 1305 for wireless communication includes means for receiving information that indicates a configuration for a first cell associated with a first cell identifier, the configuration referencing a second cell identifier associated with a second cell that is a serving cell; means for receiving an indication that the serving cell is to change from the second cell to a third cell associated with a third cell identifier; means for communicating according to the configuration by using the second cell identifier for the third cell and the third cell identifier for the second cell; means for communicating according to the configuration by replacing the second cell identifier in the configuration with the third cell identifier; and/or means for communicating, responsive to the indication, independently of the configuration. The aforementioned means may be one or more of the aforementioned components of the apparatus 1200 and/or the processing system 1310 of the apparatus 1305 configured to perform the functions recited by the aforementioned means. As described elsewhere herein, the processing system 1310 may include the TX MIMO processor 266, the receive processor 258, and/or the controller/processor 280. In one configuration, the aforementioned means may be the TX MIMO processor 266, the receive processor 258, and/or the controller/processor 280 configured to perform the functions and/or operations recited herein.

FIG. 13 is provided as an example. Other examples may differ from what is described in connection with FIG. 13.

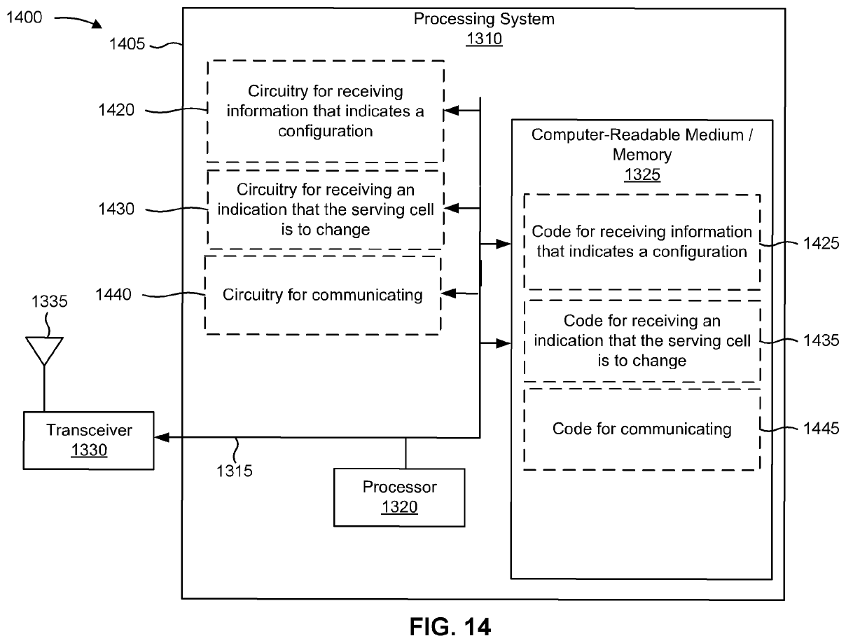

FIG. 14 is a diagram illustrating an example 1400 of an implementation of code and circuitry for an apparatus 1405, in accordance with the present disclosure. The apparatus 1405 may be a UE, or a UE may include the apparatus 1405.

As shown in FIG. 14, the apparatus 1405 may include circuitry for receiving information that indicates a configuration for a first cell associated with a first cell identifier, the configuration referencing a second cell identifier associated with a second cell that is a serving cell (circuitry 1420). For example, the circuitry 1420 may enable the apparatus 1405 to receive information that indicates a configuration for a first cell associated with a first cell identifier, the configuration referencing a second cell identifier associated with a second cell that is a serving cell.

As shown in FIG. 14, the apparatus 1405 may include, stored in computer-readable medium 1325, code for receiving information that indicates a configuration for a first cell associated with a first cell identifier, the configuration referencing a second cell identifier associated with a second cell that is a serving cell (code 1425). For example, the code 1425, when executed by processor 1320, may cause processor 1320 to cause transceiver 1330 to receive information that indicates a configuration for a first cell associated with a first cell identifier, the configuration referencing a second cell identifier associated with a second cell that is a serving cell.

As shown in FIG. 14, the apparatus 1405 may include circuitry for receiving an indication that the serving cell is to change from the second cell to a third cell associated with a third cell identifier (circuitry 1430). For example, the circuitry 1430 may enable the apparatus 1405 to receive an indication that the serving cell is to change from the second cell to a third cell associated with a third cell identifier.

As shown in FIG. 14, the apparatus 1405 may include, stored in computer-readable medium 1325, code for receiving an indication that the serving cell is to change from the second cell to a third cell associated with a third cell identifier (code 1435). For example, the code 1435, when executed by processor 1320, may cause processor 1320 to cause transceiver 1330 to receive an indication that the serving cell is to change from the second cell to a third cell associated with a third cell identifier.

As shown in FIG. 14, the apparatus 1405 may include circuitry for communicating according to the configuration, by using the second cell identifier for the third cell and the third cell identifier for the second cell or by replacing the second cell identifier in the configuration with the third cell identifier, or independently of the configuration (circuitry 1440). For example, the circuitry 1440 may enable the apparatus 1405 to communicate according to the configuration, by using the second cell identifier for the third cell and the third cell identifier for the second cell or by replacing the second cell identifier in the configuration with the third cell identifier, or independently of the configuration.

As shown in FIG. 14, the apparatus 1405 may include, stored in computer-readable medium 1325, code for communicating according to the configuration, by using the second cell identifier for the third cell and the third cell identifier for the second cell or by replacing the second cell identifier in the configuration with the third cell identifier, or independently of the configuration (code 1445). For example, the code 1445, when executed by processor 1320, may cause processor 1320 to cause transceiver 1330 to communicate according to the configuration, by using the second cell identifier for the third cell and the third cell identifier for the second cell or by replacing the second cell identifier in the configuration with the third cell identifier, or independently of the configuration.

FIG. 14 is provided as an example. Other examples may differ from what is described in connection with FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 150. The communication manager 150 may include a configuration component 1508, among other examples.

In some aspects, the apparatus 1500 may be configured to perform one or more operations described herein in connection with FIGS. 4A-4D and 5. Additionally, or alternatively, the apparatus 1500 may be configured to perform one or more processes described herein, such as process 900 of FIG. 9, process 1000 of FIG. 10, process 1100 of FIG. 11, or a combination thereof. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The transmission component 1504 may transmit information that indicates a configuration for a first cell associated with a first cell identifier, the configuration referencing a second cell identifier associated with a second cell that is a serving cell. The transmission component 1504 may transmit an indication that the serving cell is to change from the second cell to a third cell associated with a third cell identifier.

In some aspects, the configuration component 1508 may implicitly swap the third cell identifier and the second cell identifier by using the second cell identifier for the third cell and the third cell identifier for the second cell. The reception component 1502 and/or the transmission component 1504 may communicate according to the configuration by using the second cell identifier for the third cell and the third cell identifier for the second cell.

In some aspects, the configuration component 1508 may implicitly update the configuration for the first cell by replacing the second cell identifier in the configuration with the third cell identifier. The reception component 1502 and/or the transmission component 1504 may communicate according to the configuration by replacing the second cell identifier in the configuration with the third cell identifier.

In some aspects, the configuration component 1508 may suspend the configuration. The reception component 1502 and/or the transmission component 1504 may communicate, responsive to the indication, independently of the configuration. The transmission component 1504 may transmit an update to the configuration that updates the second cell identifier to the third cell identifier. The reception component 1502 and/or the transmission component 1504 may communicate, responsive to the update, according to the configuration.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

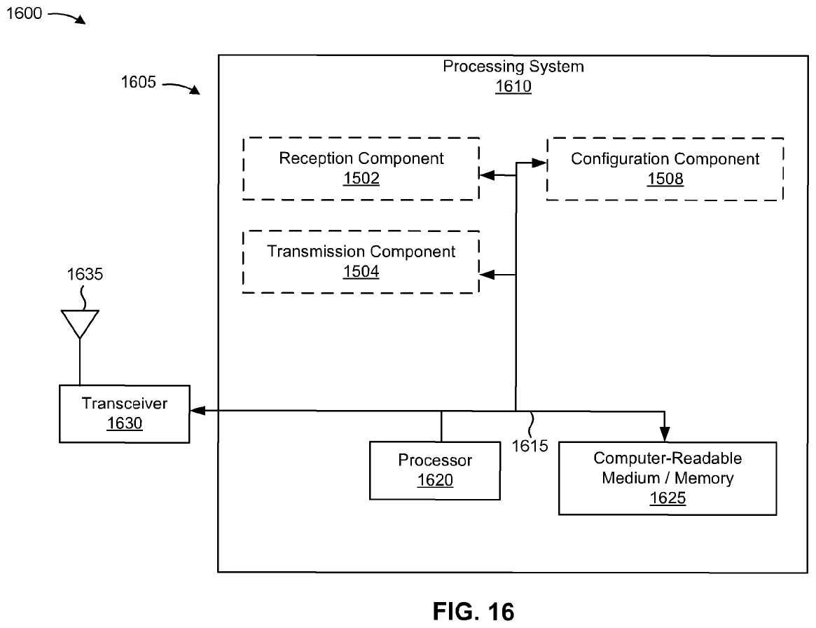

FIG. 16 is a diagram illustrating an example 1600 of a hardware implementation for an apparatus 1605 employing a processing system 1610, in accordance with the present disclosure. The apparatus 1605 may be a network node.

The processing system 1610 may be implemented with a bus architecture, represented generally by the bus 1615. The bus 1615 may include any number of interconnecting buses and bridges depending on the specific application of the processing system 1610 and the overall design constraints. The bus 1615 links together various circuits including one or more processors and/or hardware components, represented by the processor 1620, the illustrated components, and the computer-readable medium/memory 1625. The bus 1615 may also link various other circuits, such as timing sources, peripherals, voltage regulators, and/or power management circuits.

The processing system 1610 may be coupled to a transceiver 1630. The transceiver 1630 is coupled to one or more antennas 1635. The transceiver 1630 provides a means for communicating with various other apparatuses over a transmission medium. The transceiver 1630 receives a signal from the one or more antennas 1635, extracts information from the received signal, and provides the extracted information to the processing system 1610, specifically the reception component 1502. In addition, the transceiver 1630 receives information from the processing system 1610, specifically the transmission component 1504, and generates a signal to be applied to the one or more antennas 1635 based at least in part on the received information.

The processing system 1610 includes a processor 1620 coupled to a computer-readable medium/memory 1625. The processor 1620 is responsible for general processing, including the execution of software stored on the computer-readable medium/memory 1625. The software, when executed by the processor 1620, causes the processing system 1610 to perform the various functions described herein for any particular apparatus. The computer-readable medium/memory 1625 may also be used for storing data that is manipulated by the processor 1620 when executing software. The processing system further includes at least one of the illustrated components. The components may be software modules running in the processor 1620, resident/stored in the computer readable medium/memory 1625, one or more hardware modules coupled to the processor 1620, or some combination thereof.

In some aspects, the processing system 1610 may be a component of the network node 110 and may include the memory 242 and/or at least one of the TX MIMO processor 230, the receive processor 238, and/or the controller/processor 240. In some aspects, the apparatus 1605 for wireless communication includes means for transmitting information that indicates a configuration for a first cell associated with a first cell identifier, the configuration referencing a second cell identifier associated with a second cell that is a serving cell; means for transmitting an indication that the serving cell is to change from the second cell to a third cell associated with a third cell identifier; means for communicating according to the configuration by using the second cell identifier for the third cell and the third cell identifier for the second cell; means for communicating according to the configuration by replacing the second cell identifier in the configuration with the third cell identifier; and/or means for communicating, responsive to the indication, independently of the configuration. The aforementioned means may be one or more of the aforementioned components of the apparatus 1500 and/or the processing system 1610 of the apparatus 1605 configured to perform the functions recited by the aforementioned means. As described elsewhere herein, the processing system 1610 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 16 is provided as an example. Other examples may differ from what is described in connection with FIG. 16.

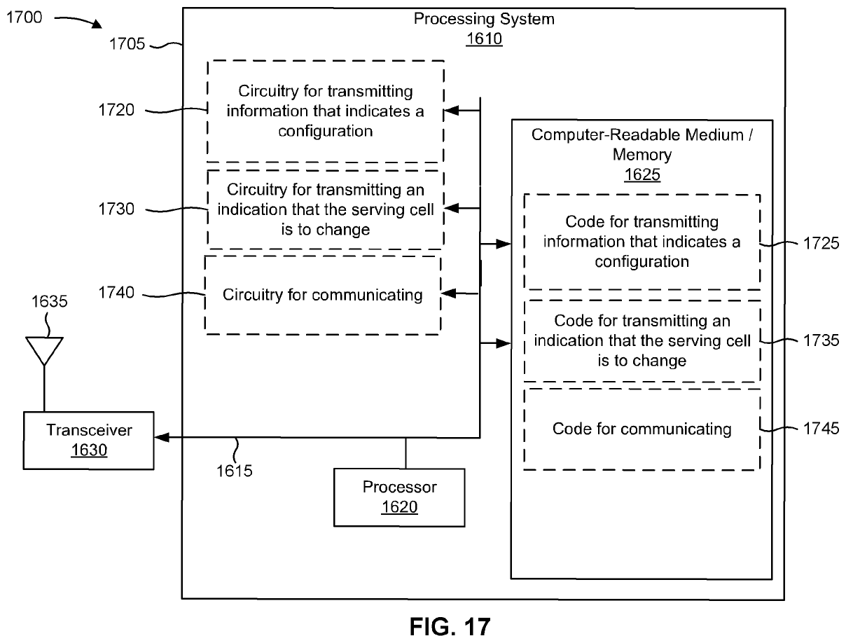

FIG. 17 is a diagram illustrating an example 1700 of an implementation of code and circuitry for an apparatus 1705, in accordance with the present disclosure. The apparatus 1705 may be a network node, or a network node may include the apparatus 1705.

As shown in FIG. 17, the apparatus 1705 may include circuitry for transmitting information that indicates a configuration for a first cell associated with a first cell identifier, the configuration referencing a second cell identifier associated with a second cell that is a serving cell (circuitry 1720). For example, the circuitry 1720 may enable the apparatus 1705 to transmit information that indicates a configuration for a first cell associated with a first cell identifier, the configuration referencing a second cell identifier associated with a second cell that is a serving cell.

As shown in FIG. 17, the apparatus 1705 may include, stored in computer-readable medium 1625, code for transmitting information that indicates a configuration for a first cell associated with a first cell identifier, the configuration referencing a second cell identifier associated with a second cell that is a serving cell (code 1725). For example, the code 1725, when executed by processor 1620, may cause processor 1620 to cause transceiver 1630 to transmit information that indicates a configuration for a first cell associated with a first cell identifier, the configuration referencing a second cell identifier associated with a second cell that is a serving cell.

As shown in FIG. 17, the apparatus 1705 may include circuitry for transmitting an indication that the serving cell is to change from the second cell to a third cell associated with a third cell identifier (circuitry 1730). For example, the circuitry 1730 may enable the apparatus 1705 to transmit an indication that the serving cell is to change from the second cell to a third cell associated with a third cell identifier.

As shown in FIG. 17, the apparatus 1705 may include, stored in computer-readable medium 1625, code for transmitting an indication that the serving cell is to change from the second cell to a third cell associated with a third cell identifier (code 1735). For example, the code 1735, when executed by processor 1620, may cause processor 1620 to cause transceiver 1630 to transmit an indication that the serving cell is to change from the second cell to a third cell associated with a third cell identifier.

As shown in FIG. 17, the apparatus 1705 may include circuitry for communicating according to the configuration, by using the second cell identifier for the third cell and the third cell identifier for the second cell or by replacing the second cell identifier in the configuration with the third cell identifier, or independently of the configuration (circuitry 1740). For example, the circuitry 1740 may enable the apparatus 1705 to communicate according to the configuration, by using the second cell identifier for the third cell and the third cell identifier for the second cell or by replacing the second cell identifier in the configuration with the third cell identifier, or independently of the configuration.

As shown in FIG. 17, the apparatus 1705 may include, stored in computer-readable medium 1625, code for communicating according to the configuration, by using the second cell identifier for the third cell and the third cell identifier for the second cell or by replacing the second cell identifier in the configuration with the third cell identifier, or independently of the configuration (code 1745). For example, the code 1745, when executed by processor 1620, may cause processor 1620 to cause transceiver 1630 to communicate according to the configuration, by using the second cell identifier for the third cell and the third cell identifier for the second cell or by replacing the second cell identifier in the configuration with the third cell identifier, or independently of the configuration.

FIG. 17 is provided as an example. Other examples may differ from what is described in connection with FIG. 17.

The following provides an overview of some Aspects of the present disclosure:

Aspect 1: A method of wireless communication performed at a user equipment (UE), comprising: receiving information that indicates a configuration for a first cell associated with a first cell identifier, the configuration referencing a second cell identifier associated with a second cell that is a serving cell; receiving an indication that the serving cell is to change from the second cell to a third cell associated with a third cell identifier; and communicating according to the configuration by using the second cell identifier for the third cell and the third cell identifier for the second cell.

Aspect 2: The method of Aspect 1, wherein the configuration includes at least one of: a cross-carrier scheduling configuration, a transmission configuration indicator configuration, a path loss reference signal configuration, a channel state information report configuration, or a physical uplink control channel cell configuration.

Aspect 3: The method of any of Aspects 1-2, wherein a set of values that are usable for a carrier indicator field in downlink control information are unchanged by the serving cell changing from the second cell to the third cell.

Aspect 4: The method of any of Aspects 1-3, wherein the serving cell is a primary cell.

Aspect 5: The method of any of Aspects 1-4, wherein the indication is in one of downlink control information or a medium access control control element (MAC-CE).

Aspect 6: A method of wireless communication performed at a user equipment (UE), comprising: receiving information that indicates a configuration for a first cell associated with a first cell identifier, the configuration referencing a second cell identifier associated with a second cell that is a serving cell; receiving an indication that the serving cell is to change from the second cell to a third cell associated with a third cell identifier; and communicating according to the configuration by replacing the second cell identifier in the configuration with the third cell identifier.

Aspect 7: The method of Aspect 6, wherein the configuration includes at least one of: a cross-carrier scheduling configuration, a transmission configuration indicator configuration, a path loss reference signal configuration, a channel state information report configuration, or a physical uplink control channel cell configuration.

Aspect 8: The method of any of Aspects 6-7, wherein the serving cell is a primary cell.

Aspect 9: The method of any of Aspects 6-8, wherein the indication is in one of downlink control information or a medium access control control element (MAC-CE).

Aspect 10: A method of wireless communication performed at a user equipment (UE), comprising: receiving information that indicates a configuration for a first cell associated with a first cell identifier, the configuration referencing a second cell identifier associated with a second cell that is a serving cell; receiving an indication that the serving cell is to change from the second cell to a third cell associated with a third cell identifier; and communicating, responsive to the indication, independently of the configuration.

Aspect 11: The method of Aspect 10, wherein the configuration includes at least one of: a cross-carrier scheduling configuration, a transmission configuration indicator configuration, a path loss reference signal configuration, a channel state information report configuration, or a physical uplink control channel cell configuration.

Aspect 12: The method of any of Aspects 10-11, further comprising: receiving an update to the configuration that updates the second cell identifier to the third cell identifier; and communicating, responsive to the update, according to the configuration.

Aspect 13: The method of Aspect 12, wherein the update is in one of radio resource control signaling or a medium access control control element (MAC-CE).

Aspect 14: The method of any of Aspects 10-13, wherein the serving cell is a primary cell.

Aspect 15: The method of any of Aspects 10-14, wherein the indication is in one of downlink control information or a medium access control control element (MAC-CE).

Aspect 16: A method of wireless communication performed at a network node, comprising: transmitting information that indicates a configuration for a first cell associated with a first cell identifier, the configuration referencing a second cell identifier associated with a second cell that is a serving cell; transmitting an indication that the serving cell is to change from the second cell to a third cell associated with a third cell identifier; and communicating according to the configuration by using the second cell identifier for the third cell and the third cell identifier for the second cell.

Aspect 17: The method of Aspect 16, wherein the configuration includes at least one of: a cross-carrier scheduling configuration, a transmission configuration indicator configuration, a path loss reference signal configuration, a channel state information report configuration, or a physical uplink control channel cell configuration.

Aspect 18: The method of any of Aspects 16-17, wherein a set of values that are usable for a carrier indicator field in downlink control information are unchanged by the serving cell changing from the second cell to the third cell.

Aspect 19: The method of any of Aspects 16-18, wherein the serving cell is a primary cell.

Aspect 20: The method of any of Aspects 16-19, wherein the indication is in one of downlink control information or a medium access control control element (MAC-CE).

Aspect 21: A method of wireless communication performed at a network node, comprising: transmitting information that indicates a configuration for a first cell associated with a first cell identifier, the configuration referencing a second cell identifier associated with a second cell that is a serving cell; transmitting an indication that the serving cell is to change from the second cell to a third cell associated with a third cell identifier; and communicating according to the configuration by replacing the second cell identifier in the configuration with the third cell identifier.

Aspect 22: The method of Aspect 21, wherein the configuration includes at least one of: a cross-carrier scheduling configuration, a transmission configuration indicator configuration, a path loss reference signal configuration, a channel state information report configuration, or a physical uplink control channel cell configuration.

Aspect 23: The method of any of Aspects 21-22, wherein the serving cell is a primary cell.

Aspect 24: The method of any of Aspects 21-23, wherein the indication is in one of downlink control information or a medium access control control element (MAC-CE).

Aspect 25: A method of wireless communication performed at a network node, comprising: transmitting information that indicates a configuration for a first cell associated with a first cell identifier, the configuration referencing a second cell identifier associated with a second cell that is a serving cell; transmitting an indication that the serving cell is to change from the second cell to a third cell associated with a third cell identifier; and communicating, responsive to the indication, independently of the configuration.

Aspect 26: The method of Aspect 25, wherein the configuration includes at least one of: a cross-carrier scheduling configuration, a transmission configuration indicator configuration, a path loss reference signal configuration, a channel state information report configuration, or a physical uplink control channel cell configuration.

Aspect 27: The method of any of Aspects 25-26, further comprising: transmitting an update to the configuration that updates the second cell identifier to the third cell identifier; and communicating, responsive to the update, according to the configuration.

Aspect 28: The method of Aspect 27, wherein the update is in one of radio resource control signaling or a medium access control control element (MAC-CE).

Aspect 29: The method of any of Aspects 25-28, wherein the serving cell is a primary cell.

Aspect 30: The method of any of Aspects 25-29, wherein the indication is in one of downlink control information or a medium access control control element (MAC-CE).

Aspect 31: An apparatus for wireless communication at a device, comprising a processor; memory coupled with the processor; and instructions stored in the memory and executable by the processor to cause the apparatus to perform the method of one or more of Aspects 1-5.

Aspect 32: A device for wireless communication, comprising a memory and one or more processors coupled to the memory, the one or more processors configured to perform the method of one or more of Aspects 1-5.

Aspect 33: An apparatus for wireless communication, comprising at least one means for performing the method of one or more of Aspects 1-5.

Aspect 34: A non-transitory computer-readable medium storing code for wireless communication, the code comprising instructions executable by a processor to perform the method of one or more of Aspects 1-5.

Aspect 35: A non-transitory computer-readable medium storing a set of instructions for wireless communication, the set of instructions comprising one or more instructions that, when executed by one or more processors of a device, cause the device to perform the method of one or more of Aspects 1-5.

Aspect 36: An apparatus for wireless communication at a device, comprising a processor; memory coupled with the processor; and instructions stored in the memory and executable by the processor to cause the apparatus to perform the method of one or more of Aspects 6-9.

Aspect 37: A device for wireless communication, comprising a memory and one or more processors coupled to the memory, the one or more processors configured to perform the method of one or more of Aspects 6-9.

Aspect 38: An apparatus for wireless communication, comprising at least one means for performing the method of one or more of Aspects 6-9.

Aspect 39: A non-transitory computer-readable medium storing code for wireless communication, the code comprising instructions executable by a processor to perform the method of one or more of Aspects 6-9.

Aspect 40: A non-transitory computer-readable medium storing a set of instructions for wireless communication, the set of instructions comprising one or more instructions that, when executed by one or more processors of a device, cause the device to perform the method of one or more of Aspects 6-9.

Aspect 41: An apparatus for wireless communication at a device, comprising a processor; memory coupled with the processor; and instructions stored in the memory and executable by the processor to cause the apparatus to perform the method of one or more of Aspects 10-15.

Aspect 42: A device for wireless communication, comprising a memory and one or more processors coupled to the memory, the one or more processors configured to perform the method of one or more of Aspects 10-15.

Aspect 43: An apparatus for wireless communication, comprising at least one means for performing the method of one or more of Aspects 10-15.

Aspect 44: A non-transitory computer-readable medium storing code for wireless communication, the code comprising instructions executable by a processor to perform the method of one or more of Aspects 10-15.

Aspect 45: A non-transitory computer-readable medium storing a set of instructions for wireless communication, the set of instructions comprising one or more instructions that, when executed by one or more processors of a device, cause the device to perform the method of one or more of Aspects 10-15.

Aspect 46: An apparatus for wireless communication at a device, comprising a processor; memory coupled with the processor; and instructions stored in the memory and executable by the processor to cause the apparatus to perform the method of one or more of Aspects 16-20.

Aspect 47: A device for wireless communication, comprising a memory and one or more processors coupled to the memory, the one or more processors configured to perform the method of one or more of Aspects 16-20.

Aspect 48: An apparatus for wireless communication, comprising at least one means for performing the method of one or more of Aspects 16-20.

Aspect 49: A non-transitory computer-readable medium storing code for wireless communication, the code comprising instructions executable by a processor to perform the method of one or more of Aspects 16-20.

Aspect 50: A non-transitory computer-readable medium storing a set of instructions for wireless communication, the set of instructions comprising one or more instructions that, when executed by one or more processors of a device, cause the device to perform the method of one or more of Aspects 16-20.

Aspect 51: An apparatus for wireless communication at a device, comprising a processor; memory coupled with the processor; and instructions stored in the memory and executable by the processor to cause the apparatus to perform the method of one or more of Aspects 21-24.

Aspect 52: A device for wireless communication, comprising a memory and one or more processors coupled to the memory, the one or more processors configured to perform the method of one or more of Aspects 21-24.

Aspect 53: An apparatus for wireless communication, comprising at least one means for performing the method of one or more of Aspects 21-24.

Aspect 54: A non-transitory computer-readable medium storing code for wireless communication, the code comprising instructions executable by a processor to perform the method of one or more of Aspects 21-24.

Aspect 55: A non-transitory computer-readable medium storing a set of instructions for wireless communication, the set of instructions comprising one or more instructions that, when executed by one or more processors of a device, cause the device to perform the method of one or more of Aspects 21-24.

Aspect 56: An apparatus for wireless communication at a device, comprising a processor; memory coupled with the processor; and instructions stored in the memory and executable by the processor to cause the apparatus to perform the method of one or more of Aspects 25-30.

Aspect 57: A device for wireless communication, comprising a memory and one or more processors coupled to the memory, the one or more processors configured to perform the method of one or more of Aspects 25-30.

Aspect 58: An apparatus for wireless communication, comprising at least one means for performing the method of one or more of Aspects 25-30.

Aspect 59: A non-transitory computer-readable medium storing code for wireless communication, the code comprising instructions executable by a processor to perform the method of one or more of Aspects 25-30.

Aspect 60: A non-transitory computer-readable medium storing a set of instructions for wireless communication, the set of instructions comprising one or more instructions that, when executed by one or more processors of a device, cause the device to perform the method of one or more of Aspects 25-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors coupled to the memory, the one or more processors configured to:
receive information that indicates a configuration for a first cell associated with a first cell identifier, the configuration referencing a second cell identifier associated with a second cell that is a serving cell;
receive an indication that the serving cell is to change from the second cell to a third cell associated with a third cell identifier; and
communicate according to the configuration by using the second cell identifier for the third cell and the third cell identifier for the second cell.

2. The apparatus of claim 1, wherein the configuration includes at least one of:
a cross-carrier scheduling configuration,
a transmission configuration indicator configuration,
a path loss reference signal configuration,
a channel state information report configuration, or
a physical uplink control channel cell configuration.

3. The apparatus of claim 1, wherein a set of values that are usable for a carrier indicator field in downlink control information are to be unchanged by a change of the serving cell from the second cell to the third cell.

4. The apparatus of claim 1, wherein the serving cell is a primary cell.

5. The apparatus of claim 1, wherein the indication is in one of downlink control information or a medium access control control element (MAC-CE).

6. An apparatus for wireless communication at an UE, comprising:
a memory; and
one or more processors coupled to the memory, the one or more processors configured to:
receive information that indicates a configuration for a first cell associated with a first cell identifier, the configuration referencing a second cell identifier associated with a second cell that is a serving cell;
receive an indication that the serving cell is to change from the second cell to a third cell associated with a third cell identifier; and
communicate according to the configuration by replacing the second cell identifier in the configuration with the third cell identifier.

7. The apparatus of claim 6, wherein the configuration includes at least one of:
a cross-carrier scheduling configuration,
a transmission configuration indicator configuration,
a path loss reference signal configuration,
a channel state information report configuration, or
a physical uplink control channel cell configuration.

8. The apparatus of claim 6, wherein the serving cell is a primary cell.

9. The apparatus of claim 6, wherein the indication is in one of downlink control information or a medium access control control element (MAC-CE).

10. An apparatus for wireless communication at an UE, comprising:
a memory; and
one or more processors coupled to the memory, the one or more processors configured to:
receive information that indicates a configuration for a first cell associated with a first cell identifier, the configuration referencing a second cell identifier associated with a second cell that is a serving cell;
receive an indication that the serving cell is to change from the second cell to a third cell associated with a third cell identifier; and
communicate, responsive to the indication, independently of the configuration.

11. The apparatus of claim 10, wherein the configuration includes at least one of:
a cross-carrier scheduling configuration,
a transmission configuration indicator configuration,
a path loss reference signal configuration,
a channel state information report configuration, or
a physical uplink control channel cell configuration.

12. The apparatus of claim 10, wherein the one or more processors are further configured to:
receive an update to the configuration that updates the second cell identifier to the third cell identifier; and
communicate, responsive to the update, according to the configuration.

13. The apparatus of claim 12, wherein the update is in one of radio resource control signaling or a medium access control control element (MAC-CE).

14. The apparatus of claim 10, wherein the serving cell is a primary cell.

15. The apparatus of claim 10, wherein the indication is in one of downlink control information or a medium access control control element (MAC-CE).

16. An apparatus for wireless communication at a network node, comprising:
a memory; and
one or more processors coupled to the memory, the one or more processors configured to:
transmit information that indicates a configuration for a first cell associated with a first cell identifier, the configuration referencing a second cell identifier associated with a second cell that is a serving cell;
transmit an indication that the serving cell is to change from the second cell to a third cell associated with a third cell identifier; and
communicate according to the configuration by using the second cell identifier for the third cell and the third cell identifier for the second cell.

17. The apparatus of claim 16, wherein the configuration includes at least one of:
a cross-carrier scheduling configuration,
a transmission configuration indicator configuration,
a path loss reference signal configuration,
a channel state information report configuration, or
a physical uplink control channel cell configuration.

18. The apparatus of claim 16, wherein a set of values that are usable for a carrier indicator field in downlink control information are to be unchanged by a change of the serving cell from the second cell to the third cell.

19. The apparatus of claim 16, wherein the serving cell is a primary cell.

20. The apparatus of claim 16, wherein the indication is in one of downlink control information or a medium access control control element (MAC-CE).

21. An apparatus for wireless communication at a network node, comprising:
a memory; and
one or more processors coupled to the memory, the one or more processors configured to:
transmit information that indicates a configuration for a first cell associated with a first cell identifier, the configuration referencing a second cell identifier associated with a second cell that is a serving cell;
transmit an indication that the serving cell is to change from the second cell to a third cell associated with a third cell identifier; and
communicate according to the configuration by replacing the second cell identifier in the configuration with the third cell identifier.

22. The apparatus of claim 21, wherein the configuration includes at least one of:
a cross-carrier scheduling configuration,
a transmission configuration indicator configuration,
a path loss reference signal configuration,
a channel state information report configuration, or
a physical uplink control channel cell configuration.

23. The apparatus of claim 21, wherein the serving cell is a primary cell.

24. The apparatus of claim 21, wherein the indication is in one of downlink control information or a medium access control control element (MAC-CE).

25. An apparatus for wireless communication at a network node, comprising:
a memory; and
one or more processors coupled to the memory, the one or more processors configured to:
transmit information that indicates a configuration for a first cell associated with a first cell identifier, the configuration referencing a second cell identifier associated with a second cell that is a serving cell;
transmit an indication that the serving cell is to change from the second cell to a third cell associated with a third cell identifier; and
communicate, responsive to the indication, independently of the configuration.

26. The apparatus of claim 25, wherein the configuration includes at least one of:
a cross-carrier scheduling configuration,
a transmission configuration indicator configuration,
a path loss reference signal configuration,
a channel state information report configuration, or
a physical uplink control channel cell configuration.

27. The apparatus of claim 25, wherein the one or more processors are further configured to:
transmit an update to the configuration that updates the second cell identifier to the third cell identifier; and
communicate, responsive to the update, according to the configuration.

28. The apparatus of claim 27, wherein the update is in one of radio resource control signaling or a medium access control control element (MAC-CE).

29. The apparatus of claim 25, wherein the serving cell is a primary cell.

30. The apparatus of claim 25, wherein the indication is in one of downlink control information or a medium access control control element (MAC-CE).
